(19) United States
(12) Patent Application Publication
(10) Pub. No.: US 2024/0086804 A1
(43) Pub. Date: Mar. 14, 2024

(54) System and Method for Schedule Optimization Including Location Clustering

(71) Applicant: Hubstar International Limited, London (GB)

(72) Inventors: Stefanos VATIDIS, London (GB); Denis MEQUINION, London (GB)

(21) Appl. No.: 17/941,234

(22) Filed: Sep. 9, 2022

(51) Int. Cl. G06Q 10/06; G06Q 10/10

(52) U.S. Cl. CPC G06Q 10/06315; G06Q 10/06314; G06Q 10/1093

(57) ABSTRACT

A computer-implemented method of optimising allocation of resources in a building, comprising: identifying a plurality of resource zones within the building, each resource zone comprising a plurality of resources for allocation; determining an expected resource utilization for each resource zone for each of a plurality of time periods across a specified time range, the determining an expected resource utilization comprising determining a number of resources within the resource zone that have already been allocated to a respective number of persons at each time period, wherein the expected resource utilization comprises an indication of the number of resources that have already been allocated; and determining a suggested resource allocation, wherein the suggested resource allocation comprises a suggested additional allocation of resources and/or a suggested reallocation of already allocated resources, and wherein the suggested resource allocation is an allocation of one or more resources in one or more resource zones for a suggested time period within the specified time range, such that after allocation according to the suggested resource allocation, the expected resource utilization of the one or more resource zones for the suggested time period is within a specified value range.

### TECHNICAL FIELD

The present disclosure relates to systems and methods for allocating resources within a specified time range to optimise utilization of the resources.

### BACKGROUND

Recent workplace trends have resulted in a change in occupancy levels in a building. Where previously workers would attend every day and utilize the same resources, it is becoming the norm to attend on certain days only, and work from home for the remainder. A consequence of this trend is that the allocation of permanently assigned workstations to employees would result in significant numbers of workstations remaining regularly vacant. With attendance trending towards 2 or 3 days per week, as much as 50% of office space and the associated maintenance, lighting, heating and cooling could be potentially wasted.

### SUMMARY

The embodiments described herein relate to a computer-implemented method and system for optimising allocation of resources in one or more physical spaces, comprising: identifying a plurality of resource zones within the one or more physical spaces, each resource zone comprising a plurality of resources for allocation; determining an expected resource utilization for each resource zone for each of a plurality of time periods across a specified time range, the determining an expected resource utilization comprising determining a number of resources within the resource zone that have already been allocated to a respective number of persons at each time period, wherein the expected resource utilization comprises an indication of the number of resources that have already been allocated; and determining a suggested resource allocation, wherein the suggested resource allocation comprises an additional allocation of resources and/or a reallocation of already allocated resources, and wherein the suggested resource allocation is an allocation of one or more resources in one or more resource zones for a suggested time period within the specified time range, such that after allocation according to the suggested resource allocation, the expected resource utilization of the one or more resource zones for the suggested time period is within a specified value range.

The disclosed methods and systems are provided in the context of an environment where flexible seating is in place, allowing employees to book workstations and meeting rooms according to their needs. Resources may be allocated that occupy one or more physical spaces (e.g. one or more buildings). By determining the suggested resource allocation with the above method, the resources may be allocated to occupants to provide more consistent occupancy levels across a specified time range (for example, across a week), and avoid large fluctuations in resource utilization through the time period.

Fluctuations in resource utilization are undesirable. For example, peaks in occupancy may place an undesired burden on the individuals utilising the resources during the peak (for example, uncomfortable overcrowding), and also a burden on the environmental systems and the power supply suppling power to utilized resources. Troughs in occupancy may reduce the opportunities for effective working between individuals who are present (such as requiring unnecessary telephone calls or walking across the office building), and also may result in wasted energy (for example in maintaining environmental conditions of under-utilized areas, or maintain a power supply for a bank of workstations for which only a few are utilized). A more consistent resource allocation reduces the likelihood of peaks or troughs in occupancy at certain points of time within the time range and minimises the undesired waste or discomfort levels. For brevity, embodiments described below are described in the context of the allocation of resources within a building, but it will be appreciated that resources may be allocated from any type of physical space (e.g. external/outdoor regions, resources within vehicles (e.g. trains), etc.).

In a ‘Hybrid’ Workplace environment, employees may work in the office or remotely. A proportion mainly work from the office, some mainly remotely, with a substantial portion of employee attendance tending towards two or three days in-office per week. This means significant variations in the level of workplace occupancy can be observed. Determining a suggested resource allocation, in accordance with the methods described above and herein, is more effective in ensuring a consistent occupancy in the building (as compared to allowing individuals a free choice in their requested resource allocation).

When provided with a free choice in reserving resources (and without the influence of the disclosed system and method), individuals will tend to follow the trends of choice of the mainstream when requesting resources be allocated to them. For example, if a team member sees that on one day of a given week more desks have already been allocated to other members of their team or other building occupants, that team member will likely choose to also work that day in the office (instead of another day in the office where no one is currently scheduled to work). Thus, high occupancy periods are likely to be reinforced and occupancy of low periods are likely to be further reduced. This results in very high occupancy peaks and troughs. So, for example, Mondays or Tuesdays might be overflowing ‘because everyone is in’ so collaboration and social interaction is guaranteed, whereas ‘no one is in on Fridays’, therefore making Fridays an undesirable day for attendance, reinforcing a low occupancy trend.

This reinforcement of existent trends can be defined by the term ‘Occupancy Resonance’ (OR). When OR occurs, peak occupancy is equal to the available total capacity (one to one allocation) and minimum occupancy is tending to zero. At OR both Peak and Minimum Utilization are furthest from the average. The systems and method described herein suggest resource allocations to achieve a more consistent occupancy level across a time period. This is not only more efficient in terms of the allocations chosen by the system, but further improved efficiency by reducing the effect of OR and reducing feedback in user-driven reservations. OR will subside as peaks tend towards the average, trending to zero when utilization is constant across the time range. Thus, the overall building resources may be more efficiently utilized in terms of power and environmental efficiency, as well as providing a more comfortable and collaborative working environment to the building occupants.

In one embodiment, determining the expected resource utilization for each resource zone comprises predicting future allocations of resources for the resource zone, the predicting comprising:
identifying a rate of allocation of resources of the resource zone at each time period; and
determining an expected total number of future allocations at each time period based on the identified rate of allocation, wherein the expected resource utilization further comprises an indication of the expected total number of future allocations.

In one embodiment, the computer-implemented method further comprises:
identifying a time period within the specified time range at which the expected resource utilization for one or more resource zones falls outside the specified value range;
identifying one or more collaborative groups of persons, each group comprising a plurality of group members;
determining, for each collaborative group, an expected group resource utilization for the time period, the determining the expected group resource utilization comprises:
   determining a number of resources of the resource zone already allocated to a respective number of group members:
   determining a rate of allocation of resources of the resource zone to group members for each time period and determining an expected total number of future allocations to group members at each time period based on the identified rate of allocation,
wherein the expected group resource utilization comprises an indication of the number of resources within the resource zone that have already been allocated to a respective number of group members at each time period, and an indication of the expected total number of future allocations to group members at each time period; and
determining a suggested group resource allocation, wherein the suggested group resource allocation comprises a suggested additional allocation of resources to group members of a specified group and/or a suggested reallocation of resources already allocated to group members of the specified group, wherein the suggested group resource allocation is an allocation of one or more resources in one or more resource zones for a suggested time period within the specified time range, such that after allocation according to the suggested group resource allocation, the expected resource utilization of the one or more resource zones for the suggested time period is within a specified value range.

Optionally, the specified group is the group having the greatest rate of allocation of resources for a resource zone and/or the lowest number of resources already allocated to the resource zone.

Optionally, identifying one or more closed resource zones, each closed resource zone comprising a plurality of resources that are not available for allocation, and wherein determining a suggested group allocation further comprises:
opening the one or more closed resource zones to create one or more opened resource zones such that the plurality of resources within the one or more opened resource zones are available for allocation; and
identifying the one or more opened resources zones as the one or more resource zones of the suggested group resource allocation.

In one embodiment, the suggested resource allocation comprises the suggested additional allocation of resources, the method further comprising:
receiving a request for allocation of one or more resources to one or more persons for a time period within a specified time range;
allocating one or more resources to the one or more persons according to the suggested additional resource allocation.

In one embodiment, the request comprises an indication of user preferences, the user preferences comprising a preferred time period and resource requirements, and wherein the one or more resources of the suggested additional resource allocation are selected based on the user preferences.

Optionally, the one or more resources of the resource allocation comprises a list of available resources for allocation ranked according to the user preferences.

In one embodiment, the computer implemented method further comprises:
receiving a request to schedule a meeting for a group of attendees for a time period within the specified time range;
identifying attendees of the group yet to be allocated resources within the specified time range; and
determining a suggested group resource allocation, wherein the suggested group resource allocation comprises a suggested additional allocation of resources to group members of the group and/or a suggested reallocation of resources already allocated to group members of the group, the determining a suggested resource group allocation comprising identifying one or more preferred resource zones as having enough resources for allocation to the entire group, and wherein the suggested group resource allocation is an allocation of one or more resources in the one or more preferred resource zones for a suggested time period within the specified time range, such that after allocation according to the suggested group resource allocation, the expected resource utilization of the one or more resource zones for the suggested time period is within a specified value range.

Optionally, the computer-implemented method further comprises:
identifying attendees of the group of attendees that already have resources allocated to them within the specified time range; and
determining a revised group resource allocation, the revised group resource allocation being an allocation of one or more alternative resources in one or more resource zones for the attendees that have already been allocated resources for a time period that is not the suggested time period.

In one embodiment, the specified value range comprises one or both of a minimum utilization threshold and a maximum utilization threshold.

In one embodiment, determining the expected resource utilization comprises analysing historical utilization data of each resource zone to determine the expected utilization of permanently allocated resources in the resource zone at each point in time.

In one embodiment, the suggested resource allocation comprises the suggested reallocation of already allocated resources, and wherein the determining a suggested resource allocation comprises:
identifying one or more suboptimal resource zones, each suboptimal resource zone being a resource zone having an expected resource utilization that falls outside the specified value range for a time period within the specified time range; and
identifying an existing resource allocation, the existing resource allocation comprising one or more allocated resources within the one or more suboptimal resource zones at the time period, wherein the suggested reallocation of already allocated resources is an allocation of one or more resources in one or more resource zones at a suggested time period such that after reallocation from the existing allocation to the suggested reallocation, the expected resource utilization of the one or more resource zones for the suggested time period is within the specified value range.

Optionally, the computer-implemented method further comprises:
reallocating resources for the one or more persons from the existing resource allocation to the suggested reallocation.

Further optionally, the method further comprises, in response to determining that the expected resource utilization at the identified time period is below the minimum utilization threshold of the specified value range:
identifying each of the one or more resource zones having the resource utilization below the minimum utilization threshold as an underutilised resource zone; and
closing each underutilized resource zones such that the resources of the underutilized resource zone can no longer be allocated.

Further optionally, the computer-implemented method further comprises turning off or lowering power to a part of an environmental system configured to change an environmental condition of each underutilized zone and/or turning off or lowering power to each resource within each underutilized zone.

In one embodiment, the computer-implemented method further comprises identifying a collaborative group of persons comprising a plurality of group members, wherein determining the suggested resource allocation comprises one or both of:
selecting the suggested time period for the allocation of the one or more resources for use by one or more of the plurality of group members such that the suggested time period coincides or overlaps with an allocated time period for one or more resources allocated to one or more other members of the plurality of group members; and

allocating the one or more resources in the one or more resource zones for the suggested time period such that the resources allocated to at least a subset of the plurality of group members are located spatially proximate to each other.

In one embodiment, the computer-implemented method further comprises:
identifying that the group members of the collaborative group have been allocated a communal resource for a specified time period;
wherein the suggested resource allocation is determined such that the resources allocated to the group members are located spatially proximate to the communal resource.

In one embodiment, the computer-implemented method further comprises:
identifying, for each of at least one occupant of the one or more physical spaces, a list of significant collaborators for the occupant; and
determining, for each of the at least one occupant and at each time period, a number of resources within the resource zone that have already been allocated to one or more persons on the list of significant collaborators for said occupant;
wherein determining the suggested resource allocation comprises determining, for each of the at least one occupant, an allocation of one or more resources such that the allocated one or more resources are in spatial proximity to the number of resources already allocated to the one or more significant collaborators.

In one embodiment, the computer implemented method of further comprises:
receiving a request from a user to schedule an event for a time period within the specified time range;
identifying a plurality of lists of significant collaborators, each list of significant collaborators associated with a respective occupant of the one or more physical spaces;
identifying which of the plurality of lists of significant collaborators includes the user; and identifying the occupants associated with said lists as potential attendees of the event;
determining an expected attendee resource utilization for each resource zone for each of a plurality of time periods across a specified time range, the determining an expected resource utilization comprising determining a number of resources within the resource zone that have already been allocated to the potential attendees;
determining a suggested time period for the event based on the expected attendee resource allocation.

In another aspect, there is described a computing system comprising one or more computing devices, wherein the one or more computing devices comprise one or more processors configured to:
identify a plurality of resource zones within one or more physical spaces, each resource zone comprising a plurality of resources for allocation;
determine an expected resource utilization for each resource zone for each of a plurality of time periods across a specified time range, the determining an expected resource utilization comprising determining a number of resources within the resource zone that have already been allocated to a respective number of persons at each time period, wherein the expected resource utilization comprises an indication of the number of resources that have already been allocated; and
determine a suggested resource allocation, wherein the suggested resource allocation comprises a suggested additional allocation of resources and/or a suggested reallocation of already allocated resources, and wherein the suggested resource allocation is an allocation of one or more resources in one or more resource zones for a suggested time period within the specified time range, such that after allocation according to the suggested resource allocation, the expected resource utilization of the one or more resource zones for the suggested time period is within a specified value range.

In another aspect, there is described a non-transitory computer-readable medium comprising instructions that, when executed by a processor, cause the processor to:
identify a plurality of resource zones within one or more physical spaces, each resource zone comprising a plurality of resources for allocation;
determine an expected resource utilization for each resource zone for each of a plurality of time periods across a specified time range, the determining an expected resource utilization comprising determining a number of resources within the resource zone that have already been allocated to a respective number of persons at each time period, wherein the expected resource utilization comprises an indication of the number of resources that have already been allocated; and
determine a suggested resource allocation, wherein the suggested resource allocation comprises a suggested additional allocation of resources and/or a suggested reallocation of already allocated resources, and wherein the suggested resource allocation is an allocation of one or more resources in one or more resource zones for a suggested time period within the specified time range, such that after allocation according to the suggested resource allocation, the expected resource utilization of the one or more resource zones for the suggested time period is within a specified value range.

### BRIEF DESCRIPTION OF THE FIGURES

Arrangements of the present invention will be understood and appreciated more fully from the following detailed description, made by way of example only and taken in conjunction with the following drawings.

FIG. 1 shows a schematic detailing a computer system for optimizing the allocation of resources across a specified time range.

FIG. 2A shows a schematic representation of a floor of a building.

FIG. 2B shows a table of resource utilization for different resource zones across a week.

FIG. 3 illustrates a method of resource allocation optimization in accordance with an embodiment.

FIG. 4 is a graph showing a rate of allocation of resources against time.

FIG. 5A is a schematic representation of a floor of a building, in which resources in a resource zone and a meeting room have been allocated to a collaborative group.

FIG. 5B is a schematic representation of a floor of a building, in which a meeting room has been allocated to a collaborative group.

FIG. 6A is a graph showing a rate of allocation of resources against time for a plurality of collaborative groups.

FIG. 6B is a bar chart showing the cumulative allocation of resources against time for a plurality of collaborative groups.

FIG. 7 illustrates a method of resource allocation optimisation in accordance with an embodiment.

FIG. 8 is a graph showing the projected rate of allocations for a collaborative group.

FIG. 9A is a bar chart showing the cumulative allocation of resources against time for a plurality of collaborative groups for a resource zone.

FIG. 9B is a bar chart showing the cumulative allocation of resources against time for a plurality of collaborative groups for an alternate resource zone.

FIG. 9C is a bar chart showing the cumulative allocation of resources against time for a plurality of collaborative groups for a resource zone, including reallocation.

FIG. 9D is a bar chart showing the cumulative allocation of resources against time for a plurality of collaborative groups for an alternate resource zone, including reallocation.

FIG. 10 illustrates a method for determining a suggested resource allocation in response to a request to schedule a meeting.

FIGS. 11A-11C illustrate an allocation of resources for a meeting for a floor of a building during a week.

FIG. 12 illustrates an example process for providing a suggested resource allocation in response to a user scheduling a meeting.

FIG. 13 is a schematic showing a floor of a building, where all resource zones and rooms are closed.

FIG. 14 is a schematic showing the floor of FIG. 13, after some rooms and resource zones have been opened for allocation of resources.

FIG. 15 shows an example process for managing peaks in occupancy.

FIGS. 16A-16D illustrates an example process for managing peaks and troughs in occupancy.

FIGS. 17A and 17B provide a schematic illustration of a suggestion configured to perform a suggestion process.

FIGS. 18A and 18B provide an illustration of an example process for optimising resource allocations in a building.

FIG. 19 is a schematic of a computer system in which the resource suggestion engine may be implemented.

### DETAILED DESCRIPTION

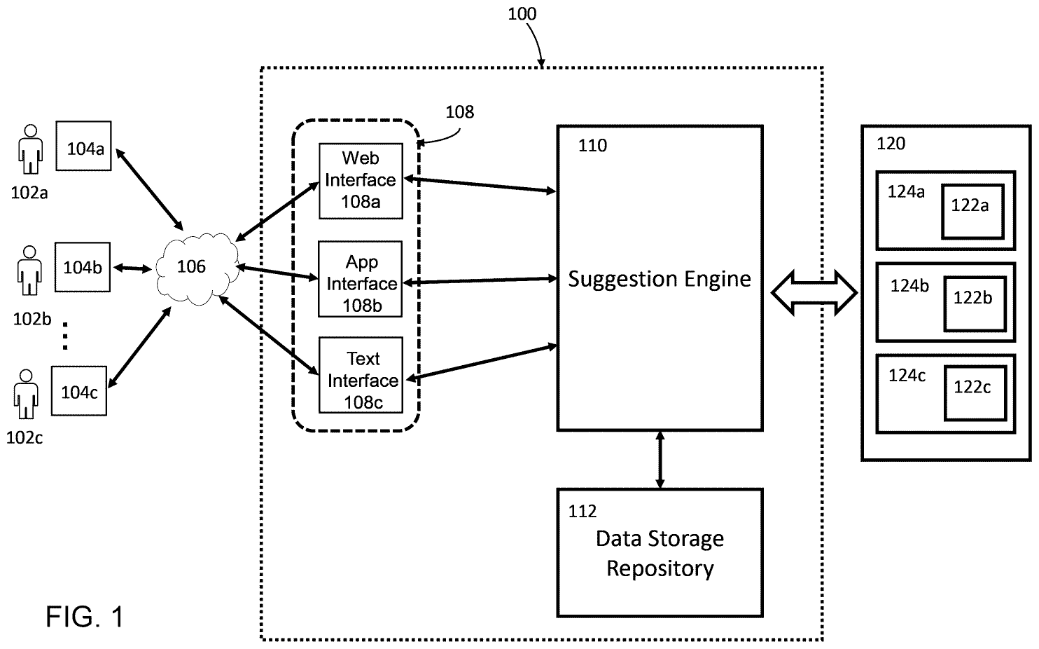

FIG. 1 shows a schematic detailing a computer system 100 for optimizing the allocation of resources across a specified time range (for example, across a week).

The computer system comprises a suggestion engine 110 configured to suggest an allocation or allocations of resources 122 within a building 120 for time increments within the specified time range (e.g. for individual days within the week). The suggestion engine is implemented on a computing device such as a server, and comprises at least one processor configured to perform the methods described herein. The resources 122 may be organized into resource zones 124. For example, building 120 comprises resource zone 124a that itself comprises resources 122a, resource zone 124b that itself comprises resources 122b and resource zone 124c that itself comprises resources 122c. The suggestion engine 110 is configured to determine a suggested resource allocation in accordance with the methods described herein.

The computer system 100 further includes a data storage repository 112 in communication with the suggestion engine 110 and which is configured to store information used by the suggestion engine 110. For example, the data storage repository 112 may store user preference information, historical usage information and/or intermediate calculations (such as periodically determined suggested resource allocations), each to be described in more detail below. The data repository 112 may be separate to, but in communication with, the suggestion engine 110 or be on the same computing device as the suggestion engine 110.

FIG. 1 additionally illustrates a plurality of client devices 104a-104c used by respective persons 102a-102c. The client devices 104a-104c may be any suitable computing devices, e.g. smartphones, tablet computers, laptop computers, desktop computers, feature phones, and/or any other computing device. The client devices 104a-104c are configured to communicate with network 106, also shown in FIG. 1. The persons 102a-102c may include a building occupant, who may use the respective client device to make a request to the computer system 100 via the network 106 to reserve a resource (i.e. to be allocated a resource). The persons may also include a team leader who may make a request using a respective user device to the computer system 100 via the network 106 to reserve a resource for himself/herself or for members of his/her team. The persons may also include a building administrator who can issue instructions to the computer system 100 via the network 106 to change the functionality of the suggestion engine 110, or provide policies or corporate rules upon which suggested allocations are based. The building administrator may also specify which resource zones are to be considered open (i.e. having resources available for allocation) or closes (i.e. resources not available for allocation).

The computer system 100 also includes one or more interfaces 108. The one or more interfaces 108 are configured to act as gateways between messages and/or requests received from the client devices 104, over the network 106, and the suggestion engine 110. The one or more interfaces 108 may be one or more computer programs implemented on a single computing device or over a plurality of computing devices. For example, each of the one or more interfaces may be implemented as individual computer programs and each of the individual computer programs may be hosted on a different computing device, or the one or more interfaces may be implemented as a single computer program hosted on a single computing device. The one or more interfaces may also be separate to, but in communication with, the suggestion engine 110 or may be components of the suggestion engine 110.

The one or more interfaces may include a web interface 108a. The web interface may facilitate communication between the client devices 104 and the suggestion engine 110 via one or more web pages and/or as a web application. The web interface 108a may receive one or more web protocol requests (e.g. HTTP requests) from a browser application on one of the client devices 104 indicating a request for allocation of resources to the respective person 102. The suggestion engine 110 may send one or more messages indicative of a suggested resource allocation to one or more of the client devices 104 via the web interface 108a.

The one or more interfaces 108 may include an app interface 108b. The app interface 108b may facilitate communication between the client devices 104 and the suggestion engine 110 via one or more services utilisable by native application(s) on the client devices 104. The app interface 108b may receive one or more service requests (e.g. application programming interface (API) requests, representational state transfer (REST) API requests, or Simple Object Access Protocol (SOAP) requests) from a native application on one of the client devices indicating a for resource allocation. The suggestion engine 110 may send one or more messages indicative of a suggested resource allocation to one or more of the client devices 104 via the app interface 108b.

The one or more interfaces 108 may include a text interface 108c. The text interface 136 may facilitate communication between the client devices 104 and the suggestion engine 110 via messages communicated between the text interface 108c and the client devices 104. The text interface 108c may receive one or more messages (e.g. short message service (SMS) messages, rich communication service (RCS) messages, messaging app messages, social network messages) from one of the client devices 104 where the one or more messages include a request for resource allocation. The suggestion engine 110 may send one or more messages indicative of a suggested resource allocation to one or more of the client devices 104 via the text interface 108b.

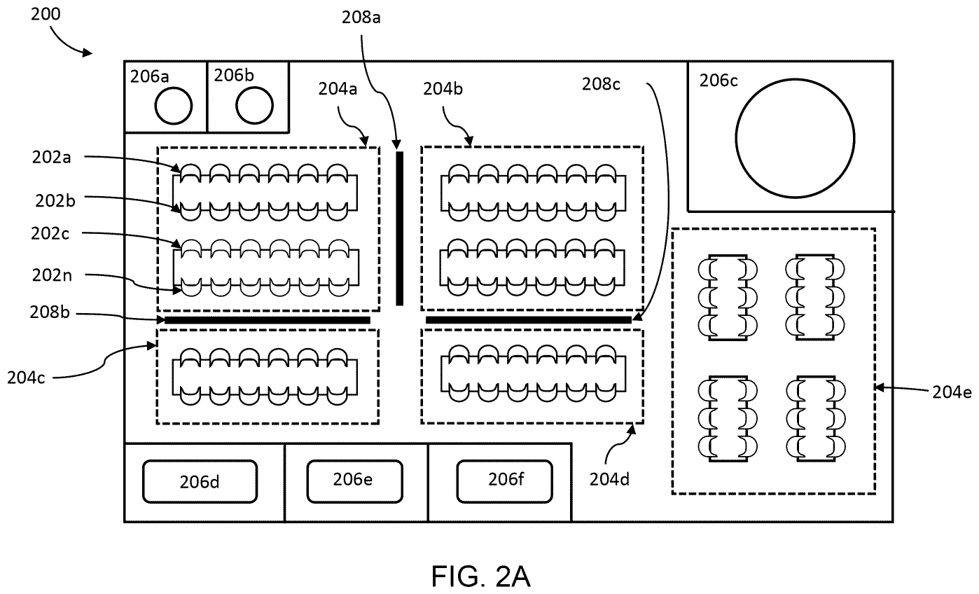

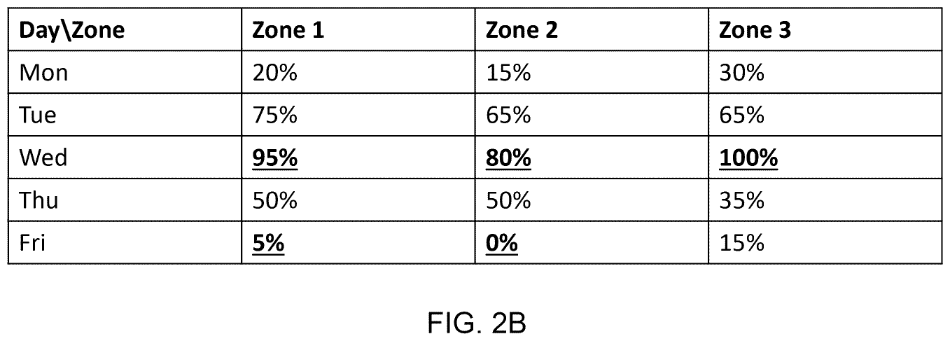

FIG. 2A illustrates an example floor 200 within a building. The floor 200 of the building includes a number of resources for allocation. The resources may include seats, table or desk space, computer workstations, printers, laptops, network ports or connections (e.g. Ethernet ports), power sources (e.g. plugs), conference call facilities, conference booths, meeting rooms, elevators and other equipment or physical space (e.g. that may be required to perform work tasks). The resources are grouped into resource zones. Each resource zone represents a number of resources in a given space/area. This can be an entire floor, the section of an open plan floor, or any other section, such as a group of flexible seating. One or more resources may themselves be certain regions or areas within the resource zone (e.g. without any association with particular equipment). For instance, various regions of a conference or event space may be allocated as resources (e.g. for users to set up booths).

Furthermore, resource zones may exist within tiers or levels. At the lowest tier of resource zones, the resources within a physical space are divided into distinct resource zones. Higher tier resource zones may include one or more composite resource zones, with each composite resource zones including a plurality of resource zones from a lower tier (or tiers). A resource zone from a lower tier may be included in more than one composite resource zones in a higher tier or tiers. In the methods described herein, the determinations of resource utilization and the determinations of suggested allocation of resources from one or more resource zones may be performed for any tier level of resource zones.

In one example, the systems and methods disclosed herein optimises resources in a building comprising multiple floors, with each floor including banks of workstations and meeting rooms. In this example, each bank of workstations and each meeting room across the building may be identified as a resource zone in a lowest tier of resource zones within the building. A second tier of resource zones in the building may include a grouping of resource zones within a particular floor of the building (for example, a logical grouping of resource zones in spatial proximity). A third tier of resource zones may include all resource zones on a particular floor. A highest tier of resource zones may include all resource zones spread across multiple floors of the building. Alternative groupings of resource zones may form higher level tiers—for example, the second tier of resource zones may also include a grouping of resource zones spread across multiple floors (for example, all resource zones that are in spatial proximity to an elevator).

FIG. 2A illustrates example resource zones 204a-204e. Each resource zone includes a plurality of resources. For example, as illustrated in FIG. 2A, a first resource zone 204a includes a plurality of resources in the form of a bank of workstations 202a, 202b, 202c . . . 202n. Each of the remaining resource zones 204b-204e in FIG. 2 are similarly illustrated to show a bank of workstations, but each resource zone may include any other type of resource and/or any number or arrangements of resources. A resource zone may be a logical grouping of resources, such as those illustrated in resource zones 204a-204e, or may alternatively be a grouping of resources constrained by physical location. For example, a resource zone may be workstations located close to a communal resource such as a printer or a coffee machine, or located close to an elevator shaft. A resource zone may otherwise be a grouping of resources defined by other parameters (e.g. a resource zone may be the group of resources serviced by the same air conditioning unit, or serviced by the same power supply, or within a specified walking distance from a fire exit). The floor further includes a plurality of partitions 208a-208c, which physically separate the resource zones from each other.

The floor also includes a number of meeting rooms 206a-206f. Each meeting room may have capacity for a different number of attendees. For example, meeting rooms 206a and 206b may be meeting rooms for one-to-one meetings, meeting rooms 206d-206f may be meeting rooms for a small group (e.g. six) individuals, whereas meeting room 206c may be a large meeting room for a large group (e.g. 10 or more). The entire floor or a section of the floor may be considered a resource zone and each meeting room may be considered a resource within that resource zone. For example, in the floor of FIG. 2A, the section encompassing meeting rooms 206d-206f may be considered a resource zone, and each meeting room a resource within that zone. Alternatively, each meeting room may itself be considered a resource zone. Resources within each meeting room (e.g. meeting room spaces, desks, equipment, etc.) may be resources for allocation. For example, a meeting room may be temporarily opened up for hot-desking.

FIG. 2A illustrates only one floor of a building. It will be appreciated that resources and resource zones may be distributed across multiple floors, multiple buildings and/or may be located outside. It is understood that the disclosure also applies to other floors, buildings or areas. which each includes its own collection of resource zones and meeting rooms. For a building with multiple floors, the floors may be identical or have varied groupings of resources into resource zones. Resource zones may incorporate resources across a number of floors. In general, resource zones may be contiguous areas/volumes, but this is not essential. The suggestion engine is able to perform resource allocation optimisation for each floor independently, or may perform resource allocation optimisation across sections of the building including multiple floors, or the entire building. Which resources zones are considered as part of the resource allocation methods may be determined through zone closures, which will be discussed in more detail below.

Each resource zone includes resources that can be allocated to individuals who are intending to occupy space in a building (or region) at a given period of time. For example, the resource zones may include a number of “hot desks” that provide workstation access for any of the building occupants who wish to reserve the desk. The resource zones may optionally include some resources that are not available for allocation, and are instead permanently allocated to an individual or to a group of individuals. For example, key support staff may be permanently allocated resources that are essential to their function in the building. The allocations are managed by the suggestion engine.

Since the resource zones include resources that are allocated to individuals in a non-permanent manner, the overall usage of the resources within each resource zone may vary across time periods (e.g. vary by day) within a larger time range (e.g. across a working week of Monday-Friday). FIG. 2B illustrates an example utilization table showing how the utilization may vary within a given week. The percentage figure given in each day for each zone represents the total number of resources that have been reserved for individuals (i.e. allocated to individuals) for the resource zone for that day of the week. For the purposes of this example, a utilization value of 80% or more is considered above optimum utilization, and a utilization value of less than 15% is considered below optimum utilization.

As can be seen, the most popular day for attendance is on a Wednesday, where each resource zone is running at or close to capacity (i.e. near or at 100%). The least popular day is Friday, where zones 1 and 2 are close to 0% utilization and thus under-utilised. Thus, some or all zones on Wednesday and Friday are not providing optimal conditions, for both management of the resources (e.g. burden on environmental systems or wasted energy) but also for collaborative opportunities and comfort (e.g. overcrowding). In addition, on Tuesday, zone 1 is very near the optimum utilization boundary and further allocations to this zone on this day would result in undesirable working conditions also on that day for zone 1. Similarly, zone 2 on Monday and zone 3 on Friday are close to being below optimum utilization. If users choose to rebook their resources from this day to another day, these zones are at risk of becoming even more under-utilized and wasteful use of energy-consuming facilities.

The disclosed systems and methods provide a way to optimise allocations such as that illustrated within FIG. 2B. For example, the system and method would aim to steer a user or groups of users away from reserving resources on any zone on Wednesday, and would instead suggest resources be booked within zones where the allocation would not move the zone into over- or under-utilized status. Similarly, the method and systems will enable reallocation of resources away from over-utilised zones to move these zones into the range in which resource utilization is at an optimum (e.g. reallocate resources from Wednesday to other days in the week). The methods and systems may also reallocate resources away from under-utilized zones entirely (such as zone 1 on Friday) and close the zone. This means, for example, that environmental systems for that zone can be turned off and resources in those resource zones powered down.

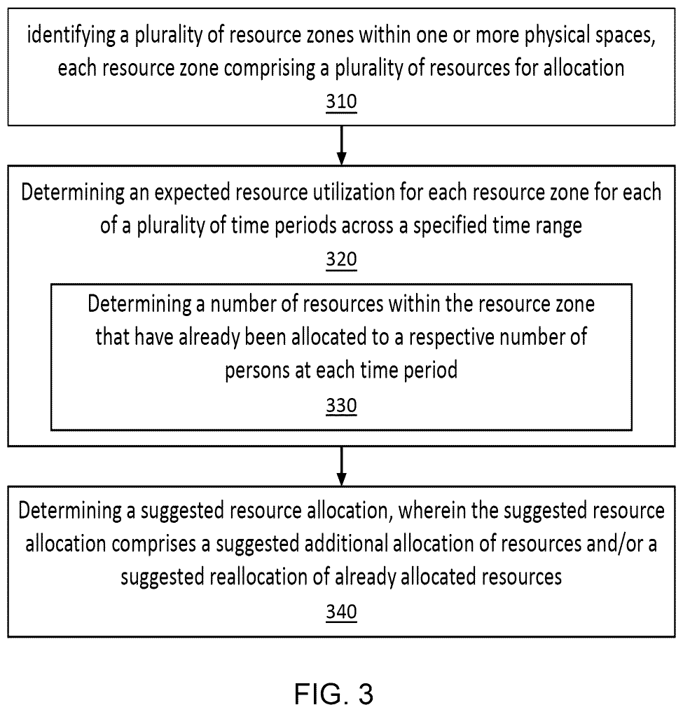

FIG. 3 illustrates a flowchart of a computer-implemented method of optimising allocation of resources in a building. The method comprises identifying 310 a plurality of resource zones within the building. Each resource zone comprises a plurality of resources for allocation. The resource zones identified may be resource zones at any tier level, as described above (e.g. may be resource zones at the lowest tier level, or may be composite resource zones at any of the higher tier levels). Optionally, one or more of the resource zones include a resource or resources 203 that are permanently allocated and not available for allocation by the suggestion engine.

The method further includes determining 320 an expected resource utilization for each resource zone for each of a plurality of time periods across a specified time range. The specified time range may be a time duration, in the future, over which the resource zone utilization is intended to be optimised. The method will consider all time periods within the specified time range when determining allocations to be made to individuals. This specified time range may be a day, a week, a month or any other period during which resources may be reserved and allocated to building occupants. Each time period may be a duration of time that makes up a smaller part of the specified time range. The time period is considered a flexible parameter for resource allocation within the specified time range. For example, in the absence of preferences or instructions to the contrary, the suggestion engine will consider resources within different time periods as substitutable, as long as those time periods are within the specified time range. The time period may be a day of the week, a week of a year or an hour of the day. Thus, the suggestion engine determines utilization for smaller time units within the larger specified time range. In the example when the specified time range is a week, the suggestion engine may determine the resource utilization for each resource zone on each day of the week.

Determining the expected resource utilization may comprise determining 330 a number of resources within the resource zone that have already been allocated to a respective number of persons at each time period. If a resource has already been booked to a user for a given time period (e.g. a given day of the week), then the resource is expected to be utilized by the person at that time period during the specified time range. The method thus determines a plurality of resource utilization values, one for each time period. The allocation status of the resources in each zone may then be used to represent the overall resource utilization at the time period. For example, the expected resource utilization may comprise an indication of the number of resources that have already been allocated. This indication may be in the form of an absolute value of allocated resources (e.g. if X resources of a zone have been allocated for time period 1, then the resource utilization of the zone is given as X for time period 1), and may also/alternatively be in the form of a utilization density, which is a percentage or fraction of the total number of resources in that zone (e.g. if X resources out of a total Y resources of a zone have already been allocated for time period 1, the resource utilization density at time period 1 is X/Y for the zone. An example of resource utilization density values for a plurality of time periods is that illustrated in FIG. 2B).

The method further includes determining 340 a suggested resource allocation. The suggestion allocation of resources is determined in order to optimise the overall resource utilization. The suggested resource allocation comprises a suggested additional allocation of resources, where one or more currently allocated resources are allocated to one or more persons, and/or a suggested reallocation of already allocated resources. The reallocation may be an allocation of completely different resources for the same time period or a different time period, or may be a reallocation of the same resources but for a different time period. The suggested resource allocation may be an allocation of one or more resources in one or more resource zones for a suggested time period within the specified time range. The suggestion engine may be provided with flexibility to consider any available resource for any time period within the specified time range.

Any allocation or reallocation of resources within a resource zone will affect the resource utilization value for that zone. Additional resource allocations will increase the resource utilization for zone that contains the resource allocation, and resource allocations away from a resource zone will lower the resource utilization for the resource zone. The suggested resource allocation is determined such that after allocation according to the suggested resource allocation, the expected resource utilization of the one or more resource zones for the suggested time period is within a specified value range. For example, the suggestion engine is able to calculate the effect on the resource utilization for each zone for all available resources at each time point the resource is available. The suggestion engine then determines the combination of available resource and time period that will maintain the resource utilization of the respective zone within the specified value range. In this manner, the suggestion engine is able to suggest a resource zone for allocation that will not push any one zone into uncomfortable over-utilization/under-utilization.

As mentioned above, the suggested resource allocation may comprise a suggested additional allocation and/or a suggested resource reallocation. The suggested additional allocation may be a single additional resource, in which case the determination of the suggested resource allocation considers the effect of the single resource allocation on overall resource utilization levels across the possible resource/time period combinations. The suggested additional allocation may alternatively be a plurality of additional resource allocations, either for one individual or for a group of individuals. In which case, the determination of the suggested resource allocation considers the effect of the multiple resource allocations on overall resource utilization levels across the possible resource/time period combination. The plurality of additional resource allocations may be determined by the suggestion engine to include different resources across different time periods, or may include different resources across the same time period.

Similarly, the suggested reallocation may be a reallocation of a single resource, in which case the determination of the suggested reallocation considers the effect of the single reallocation on overall resource utilization levels across the possible resource/time period combinations. The suggested reallocation may alternatively be a plurality of resource reallocations, either for one individual or for a group of individuals. In which case, the determination of the suggested reallocation considers the effect of the multiple reallocations on overall resource utilization levels across the possible resource/time period combination. The plurality of reallocations may be determined by the suggestion engine to include different resources across different time periods, or may include different resources across the same time period.

Through determining resource utilization based on zones, the Occupancy and Occupancy Resonance is not purely measured on overall utilization of the building, but on spatially focused areas. This allows for greater precision when assessing if resource utilization is being pushed outside optimal boundaries. However, the suggestion engine may be configured to determine average resource utilization across multiple resource zones or the entire building, and seek to keep said average resource utilization within a specified value range.

For example, the determining 320 an expected resource utilization may be performed at any or all tier levels of resource zones. For example, the expected resource utilization may comprise determining an expected composite resource zone utilization, which is the expected resource zone utilisation that is determined for a composite resource zone formed of lowest tier resource zones (e.g. for example, the expected resource zone utilization where a resource zone is the floor of a building). In one embodiment, the resource utilization may be determined across a plurality of tier levels simultaneously—for example. an expected resource utilization may be determined for each resource zone at the lowest tier, and simultaneously the expected composite resource zone utilization for composite resource zones that include one or more resource zones at the lowest tier. The expected composite resource zone utilization may be provided as an overlay to the expected resource zone utilization.

In this embodiment, the suggested resource allocation is determined such that, after allocation according to the suggested resource allocation, the expected composite resource utilization of the one or more resource zones for the suggested time period is within a composite resource zone value range. The specified composite resource zone value range may be the same as the specified value range described above (i.e. the overall utilization for groups of resource zones is to be kept within the same limits as the overall utilization for individual resource zones). Alternatively, the composite resource zone value range may be different to the specified value range. This may be the case when the resource utilization requirements and collaboration requirements may be different for larger physical spaces. As an example, a larger space (e.g. a floor) may have an upper utilization threshold that is less than that of each resource zone within that space to reflect how environmental burdens placed on the larger space (e.g. an entire floor) may differ from an individual zone. Similarly, a larger space (e.g. a floor) may have a lower utilization threshold that is less than that of each resource zone within that space.

The determination of the suggested resource allocation for multiple resources for people within collaborative groups will be discussed in detail below.

The value range defines the limits within which resource utilization is at an optimum level. For example, the specified value range may comprise one or both of a minimum utilization threshold and a maximum utilization threshold. The minimum utilization threshold may be minimum level (e.g. a minimum number of allocated resources or a minimum utilization density) above which occupancy is considered to be optimal from a collaboration standpoint—i.e. the number of proximate individuals to provide productive gains to in-office work. The minimum utilization threshold may also be a minimum level below which it is power-inefficient to maintain environmental conditions of a resource zone. The maximum utilization threshold may be a maximum level (e.g. a maximum number of allocated resources or a maximum utilization density) above which it is considered sub-optimal from a collaborative standpoint (for example, the threshold indicates the point at which the resource zone becomes overcrowded). The maximum utilization threshold may also be a maximum level above which it is power-inefficient to maintain one or more environmental conditions (for example, an increased burden is placed upon one or more air conditioning units). The maximum utilization threshold may also be a maximum level above which there are negative health effects or an increased risk of danger (e.g. overcrowding causing an increase in the transmission of illness, or an increased risk during a fire).

The minimum utilization threshold and maximum utilization thresholds may be different for each resource zone. For example, an open plan office environment may require a smaller number of people before the space begins to feel overcrowded—by comparison, an office plan divided into cubicles may accommodate a larger number of people before overcrowding is felt. Similarly, an open plan office may experience more air flow and improved temperature regulation, so could accommodate more people without overburdening the environmental systems or increasing the risk of illness being transmitted. Each threshold may be modified. For example, a user of the system (for example, a facilities manager) may decide and set the utilization thresholds for each resource zone across each tier.

Alternatively, or additionally, the thresholds may be adaptable based on observed user patterns such as historic resource utilization. For example, the system may observe over time that a resource utilization density does not exceed a certain value. The system may then infer that the resources above this amount are not being reserved because individuals have experienced lower collaboration opportunities or uncomfortable working conditions when the utilization density exceed the certain value. The suggestion engine may then automatically adjust the maximum utilization threshold to the observed value. User feedback may also be collected to adapt the thresholds. For example, users may indicate a level of comfort after utilizing a particular resource, and the suggestion engine may collate the feedback to identify a level above which (or a level below which) a majority of users have reported uncomfortable working conditions. The suggestion engine may then adjust the threshold(s) to the identified level(s).

The determining of the suggested resource allocation may comprise determining, for each resource in the one or more physical spaces, an optimization weighting for each possible allocation of the resource (e.g. each available resource at each available time). In this embodiment, the one or more resources of the suggested resource allocation comprises the resource allocation with the highest optimization weighting. The optimization weighting is a measure of how likely an allocation of the resource is to optimize the utilization of the resources within the one or more physical spaces and/or how likely the allocation of the resource is to optimize collaboration opportunities for a building occupant.

The weighting may include contributions from one or more weighting factors, which will be described below. Examples of one or more weighting factors include one or more spatial weighting factors (e.g. based on proximity to one or more locations), one or more utilization weighting factors (e.g. based on a utilization of one or more resource zones), one or more preference weighting factors (e.g. based on one or more user preferences), one or more allocation weighting factors (e.g. based on the presence of one or more already allocated resources), one or more role weighting factors, (e.g. based on one or more role preferences of a role of the user), and one or more collaboration weighting factors (e.g. based on spatial proximity to one or more resources allocated to one or more members of a collaborative group at particular time(s)).

Each weighting factor combines to create the optimization weighting, thus allowing versatility and variation in the factors contributing toward the determination of the suggested resource allocation. Each weighting factor may be positive or may be negative, to respectively make the resource allocation more likely or less likely to be suggested to the user. Each weighting factor may be multiplied by an associated modifier and combined in an additive manner. Alternatively, each weighting factor may be multiplied with one or other weighting factors. The manner by which the weighting factor contributes to the optimized weighting will depend on the comparative importance of the weighting factor in the determining of the suggested resource allocation. Each of the weighting factors below may contribute alone to the optimization weighting, or may contribute in combination with other weighting factors.

For example, in some embodiments a particular location or area may be identified as an “attractor seed”. An attractor seed may be a location or area for which proximity is likely to be important to users. Accordingly, weightings of allocations of resources in the proximity of the attractor seed are increased, thus increasing the likelihood of the suggestion engine suggesting the allocation to users of the system. One example of this is where a particularly influential user (e.g. a senior user, such as a manager) is expected to be located (e.g. an allocation of a resource to that influential user). In this case, it may be beneficial to allocate users (or a particular sub-set of users, such as those that work within a team of the influential user) close to the attractor seed. Similarly, an influential resource or resource zone (such as a meeting room that is allocated to certain users) may become an attractor seed in that it may be beneficial to allocate certain resources (e.g. desks) to the users allocated to influential resource or resource zone.

In optimizing the weighting of resources to bias selections to those closer to an attractor seed, the weighting for each resource may be determined based on the distance of the resource to the attractor seed. This distance may be a direct distance (e.g. Euclidean distance) or may be based on a path of travel between the two locations (e.g. a travel distance, taking into account any obstructions between the two locations). By taking into account distance, resources that are closer to the attractor seed may be allocated a larger weighting than resources that are further away from the attractor seed.

In other examples, the weighting of allocations of resources within a resource zone may be reduced (e.g. due to an increased utilization density within the resource zone) to reduce the likelihood of resources within the resource zone being allocated to users.

In one embodiment, the optimization weighting for each resource allocation includes a utilization weighting factor. The suggestion engine may determine a utilization weighting factor for each resource allocation based on an expected resource utilization of the system following the resource allocation. In this embodiment, the system may determine expected resource utilization of a resource zone containing the resource to be allocated. If the resource utilization following allocation of the resource at the time period falls outside the specified value range, then the suggestion engine may provide the associated resource with a low utilization weighting factor (for example, zero, if the system does not want to suggest this resource to the user at all). If the resource utilization following allocation of the resource at the time period falls within the specified value range, then the suggestion engine may provide the associated resource with a high utilization weighting factor (for example, 1). The utilization weighting factor may be determined based on resource utilization values determined for any or all tiers of resource zone. The size of the utilization weighting factor may be a function of the expected number of resources allocated to a resource zone of which the resource forms a part. For example, a resource in a resource zone that is near the lower utilization threshold may have a higher utilization weighting factor than a resource in a resource zone near the upper utilization threshold. This may encourage users to reserve resources in a utilized zone that is at lower capacity than one at higher capacity.

Where the resource belongs to multiple resource zones across different tier levels of resource zones, the suggestion engine may calculate a utilization weighting factor for each resource zone based on the resource utilization for the resource zone. The optimization weighting for each resource allocation may include the utilization weighting factors for each resource zone the resource is part of. The utilization weighting factor for each resource zone may vary depending on the tier level of resource zone. For example, the optimization at the lowest tier level may be comparatively more important than at a higher tier level, so the weighting values may be correspondingly higher.

With an optimization weighting including a utilization weighting factor, the suggested resource allocation may increase the likelihood of an allocation or reallocation of a resource to a zone where the effect of that allocation will not adjust the resource utilization of that zone to outside the specified value range. In the example where upper limit of the specified value range is a utilization density of 80%, if that zone has 40/50 resources already allocated for a Monday, the suggestion engine may lower the likelihood of an allocation or reallocation additional resources on the Monday as this will push the resource utilization outside the specified value range.

The suggested resource allocation may suggest an allocation of resources to a resource zone where the effect of that allocation will adjust the resource utilization of that zone to outside the specified value range. This suggestion may happen if no potential zones and/or times are available that would not cause this to happen (such as during a time period where every zone has a high utilization density). In this case, the suggested resource allocation may be allocated to the zone that results in the specified value range being exceeded by the smallest amount out of the available options. The suggestion engine may also suggest an allocation of resources to a resource zone where the effect of that allocation will adjust the resource utilization of that zone to outside the specified value range in circumstances where other weighting factors increase the overall optimization weighting (thus, the utilization weighting factor for a resource allocation may be low, but other weighting factors increases the utilization weighting to a higher level).

The determination of a suggested resource allocation may include an allocation of a plurality of resources to a single individual for a specified time period, or allocation of the same resource or resources for different time periods within the specified time range, or allocation of different resources for different time periods within the specified time range. For example, a building occupant may wish to be allocated a workstation in a bank of workstations (a resource zone), and also be allocated a seat in a meeting room (a different resource zone) on the same day. The worker may also request allocation of a resource (or resources) across multiple time periods within the specified time range. The resources may be the same or may be different. For example, the user may request to sit at the same desk on three days of the week. Different resource allocations given to the same user are given equal weighting as different resource allocations to different users.

The determination of the suggested resource allocation may be performed periodically, or in response to a request from an individual to allocate resources to one or more building occupants. The determination includes the determination of the suggested additional allocation of resources as well as the determination of the reallocation of resources as part of the determined suggested resource allocation. In the case when the suggested resource allocation is performed periodically, the suggestion engine stores the suggested resource allocation for reference when a user request might later be submitted to the system (or for reference in response to another trigger). In this manner, the suggestion engine keeps up-to-date with the allocations that are currently stored within the system, and will regularly reassess and update the determination. For example, a user may not accept a suggested allocation and may reserve a different resource. A subsequently determined suggested resource allocation would need to reflect this updated allocation status for the building. The suggestion engine may be configured to automatically perform the method 200 every time a resource is actually allocated, and not just in response to a request for allocation.

The suggestion engine may update the optimization weightings for each resource in the one or more physical spaces every time a suggested resource allocation is determined. For example, as allocated resources get allocated, reallocated or cancelled, the utilization weighting can change based on the changing actual number of resource allocations and changes to predicted number of resource allocations.

In one embodiment where the suggested resource allocation comprises the suggested additional allocation of resources, the method further comprises receiving a request for allocation of one or more resources to one or more persons for a time period within a specified time range. The suggestion engine then either performs the method steps of FIG. 3 to determine the suggested resource allocation, or the suggestion engine refers to a previously determined suggested resource allocation. The suggestion engine may then provide a suggested allocation to the user making the request corresponding with the suggested resource allocation. The requester may then be invited to confirm the suggested resource allocation. Following confirmation from the requester, the suggestion engine then allocates one or more resources to the one or more persons according to the suggested resource allocation.

The suggestion engine does not necessarily need to wait for an explicit request from a user to provide a suggested allocation to a building occupant. The suggestion engine may alternative proactively suggest the resource allocation to users who have not yet been allocated resources in the form of a communication (e.g. email or push notification) following any determination of a suggested resource allocation. For example, if a team leader requests calculation of an optimised allocation of resources to all members of his/her team, the suggestion engine may proactively disseminate a determined suggested resource allocation in response to that request.

In one embodiment, the request comprises an indication of user preferences. The user preferences may themselves form part of the request, or the request may include a reference or index for the suggestion engine to retrieve the user preferences from data storage. The user preferences may include utilization level preferences. For example, a user may prefer a quiet workspace so would prefer to be allocated a resource in a resource zone below a certain utilization level. The user preferences may further include a preferred time period and resource requirements. A non-exhaustive list of resource requirements includes: a requirement that a workstation be disabled accessible, a requirement that the workstation include a standing desk and a requirement that the workstation include certain computing resources such as a minimum computing power, a minimum storage space, a microphone, headset or webcam. The preferred time period may specify times where the worker is unavailable, such as a booked holiday, non-working days for part-time staff, or restricted working hours (e.g. due to childcare responsibilities).

The user preferences may be flexible user preferences (e.g. indicating merely a preferred working day), or may be mandatory user preferences with which the allocation must comply (e.g. disabled accessible workstation). In one embodiment, the optimization weighting comprises one or more preference weighting factors, where each preference weighting factor is based on a respective one of the user preferences. The preference weighting factor may be positive or negative, depending on the preference (for example, if a user requires an accessible workstation, then non-accessible workstation allocations are modified by a (e.g. large) negative number to place these suggested allocations low on the ranked list of recommendations). Different user preferences may provide a different weighting factor (for example, some user preferences may be identified as more important than others. Preferred time may have a higher preference weighting than preferred resource requirements, or preferred resource requirements may have a higher preference weighting than preferred time. Specific preferred resource requirements or specific preferred times may again be identified as relatively more important and have a higher preference weighting. For example, a certain day of the week may be considered more important than particular hours within the day.

In one embodiment, the one or more resources of the resource allocation comprises a list of available resources for allocation ranked according to the optimization weighting. The resource allocation with the highest optimization weighting is listed first, with the remainder ranked by optimization weighting. The available resource for allocation may alternatively or additionally be ranked according to any of the weighting factors. For example, the list of suggested resource allocations may be ranked according to preference weighting factor (determined based on user preferences). While each of the available resources of the list, if allocated, would provide optimised resource allocation, the list allows the requester to choose. The list may rank the options according to the weighting factors in different ways.

In one embodiment, the optimization weighting comprises an allocated resource weighting factor. An allocated resource weighting factor is determined based on the presence of one or more already allocated resources. For example, allocations of resources that are spatially proximate to one or more other already allocated resources, or resources predicted to be allocated, within the same resource zone or adjacent resource zones may have a higher allocated resource weighting factor. This weighting factor may further depend on whether the other resources have been allocated to members of a group to which the user making the request belongs (e.g. the same collaborative group). For example, if a resource is proximate to one or more resources already allocated to collaborative group member(s) for a certain time, then the allocation of that resource will have a higher allocated resource weighting factor for that time, or for times proximate to that time. The allocation weighting factor may be a function of distance to the one or more other already allocated resources. The distance may be a direct distance or a travel distance.

In further embodiments where the suggested resource allocation comprises the suggested reallocation of already allocated resources, the method further comprises steps to reallocate the resources to optimise overall resource utilization. The determination of the suggested resource allocation comprises identifying a time period within the specified time range at which the expected resource utilization for one or more resource zones falls outside the specified value range. The identification of this time period is made following a determination of resource utilization for the one or more resource zones. This may occur as part of periodic determination of a suggested resource allocation described above, or may occur as part of a determination of suggested resource allocation made in response to a trigger (e.g. after receiving an allocation request or a request to schedule a meeting). The determination of the suggested resource allocation further comprises identifying an existing resource allocation, the existing resource allocation comprising one or more allocated resources within the one or more suboptimal resource zones at the time period. The suggested reallocation of already allocated resources is an allocation of one or more resources in one or more resource zones at a suggested time period such that after reallocation from the existing allocation to the suggested reallocation, the expected resource utilization of the one or more resource zones for the suggested time period is within the specified value range.

A suboptimal resource zone may be a resource zone that has an expected resource utilization that is above an optimal utilization threshold (e.g. a maximum utilization threshold). A suboptimal zone may alternatively be a resource zone that has an expected resource utilization that is below an optimal utilization threshold (e.g. a minimum utilization threshold). The minimum utilization threshold may be less than the maximum utilization threshold. The suggested reallocation of existing resources can thus be determined with the aim of reallocating resources within resource zones so as to have resource utilization both within the specified value range.

The suggested reallocation of resources may be based on the optimization weighting and weighting factors in accordance with the embodiments described herein. The suggested reallocations provided to the user may be ranked according to optimization weighting.

The method may further comprise identifying the one or more persons to which the already allocated resources have been allocated. The suggestion engine may then provide a suggested reallocation of the already allocated resources to the one or more persons. This may take the form of a pro-active suggestion emanating from the application, via a chosen communication preference (e.g. email or an in-application notification), containing the suggested alternative allocation. The communication preference may be specified in the user preferences. As part of the suggestion, the user may be invited to confirm the suggested resource allocation. Following confirmation, the suggestion engine then reallocates resources for the one or more persons from the existing resource allocation to the revised resource allocation.

An example embodiment of such a message might be:
“We have identified that trading your booking for Desk 57 on Monday for Desk 231 on Thursday would:
   Be present on a day where the office is not as crowded
   Allow you to attend “Team Leadership Meeting” in person
   Increase your collaboration opportunities with members of your department
   Be in a location that is being environmentally controlled, and therefore more environmentally friendly
Click here to make the change.”

The determination of the suggested resource allocation may further be based on role preferences (e.g. corporate policies and drivers). Such role preferences may include information about each building occupant, including role, seniority, training and other management requirements. For example, resources within a resource zone may be preferentially allocated to a more senior staff member. In one embodiment, the optimization weighting comprises a role weight factor, where the role weight factor is determined based on a respective one of the role preferences.

To achieve transparency to the user and facilitate adoption, each and every suggestion provided to the end user may be accompanied by a justification for the suggestion, including supporting evidence of the computation. This in essence explains why a given suggestion has been produced. Although not all these elements would necessarily be directly displayed to the user, they would be accessible through progressive disclosure.

The determination of already allocated resources provides a snapshot of the state of resource allocations. If this determination is made close to the specified time range, then the number of resource allocations yet to be made may be low and the number of already allocated resources may more accurately reflect the final expected occupancy of the resource zone across the specified time range. However, reservation activity can take place weeks in advance of the actual date of the allocation, and may be continually being made throughout each day in advance of the specified time range. For example, it is likely that a large proportion of individuals will perform request allocations of resources for the upcoming weeks on a day (e.g. Friday) preceding these weeks. This means that, when based on already allocated resources, a projected occupancy for the next couple of weeks might be very fluid on that day.

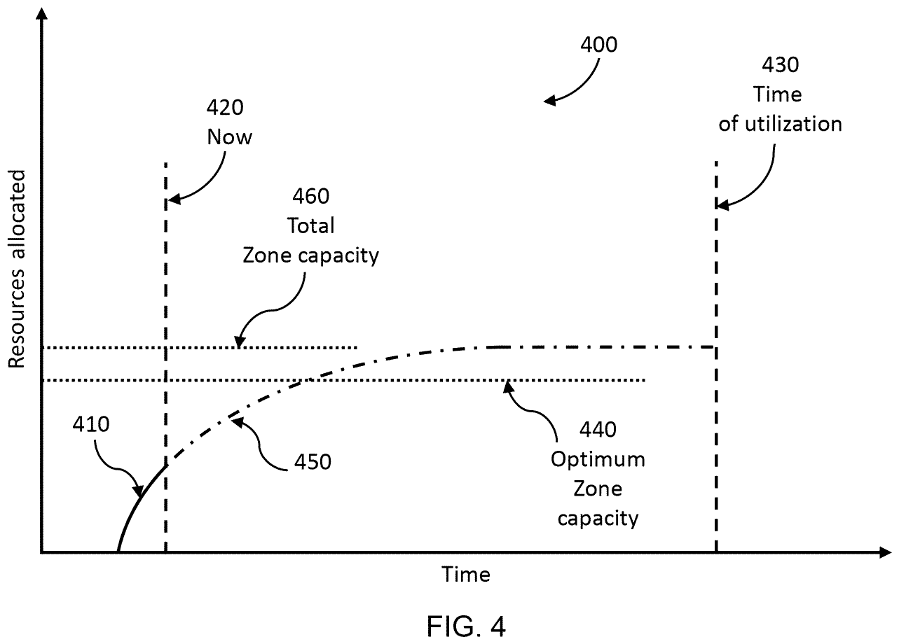

FIG. 4 shows graph 400 that illustrates how the number of allocations may change over time for one resource zone. Line 410 shows the time variation of the allocation of resources from one resource zone to building occupants, for a time period 430 at which the resources are going to be utilized. At point 420, the time at which the resource utilization is determined, the number of resources that have been allocated to the zone is below the optimum zone capacity 440. Thus, when considering only the already allocated resources when determining expected utilization, resources may still be allocated into this zone for the given time period 430 and the expected utilization is still within the optimum utilization value range.

However, as shown in FIG. 4. Line 410 indicates a trend in resource allocations over time. If the rate of allocation continues according to this current trend (shown by line 450), the number of resources that are allocated to the zone will continue to increase and surpass the optimum zone capacity 440, eventually reaching the zone capacity 460 by the time the time of utilization occurs.

In addition to the determination of already allocated resources, the determining the expected resource utilization for each resource zone comprises predicting future allocations of resources for the resource zone. Thus, the determined expected resource utilization may be more accurate and trends toward over-utilization or under-utilization may be anticipated and accounted for far in advance of the resources being allocated.

According to one embodiment, the predicting comprises identifying a rate of allocation of resources of the resource zone for each time period. For each time period within the specified time range, the suggestion engine can determine the number of resources within the resource zone that have already been allocated for that time period, as well as the point in time at which each allocation was made. From these determinations, the suggestion engine can determine a function describing the number of allocations against time for each resource zone for each time period. The suggestion engine can then determine an expected total number of future allocations at each time period, based on the identified rate of allocation and the determine allocation-time function. The expected resource utilization further comprises an indication of the expected total number of future allocations. The suggested resource allocation determined by the suggestion engine may thus anticipate zones filling to capacity and steer users toward alternative resource zones to pre-empt and avoid uncomfortable resource utilization levels. This more accurate expected resource utilization may be used by the suggestion engine to determine a utilization weighting factor, in the same manner as described above.

Optionally, the suggestion engine may utilize historical information when predicting future allocations of resources for the resource zone. For example, the suggestion engine may utilize previously observed rates of allocation when determining the allocation-time function.

Being able to adjust recommendations in advance of the actual allocations being made provides a more accurate determination of resource ulitilization. By tracking the rate at which new reservations occur, the system will be able to open or restrict resource zones based on a projection of new reservations still to occur.

As identified above, the one or more resource zones managed by the system may optionally include resources that are permanently allocated. The suggestion engine may therefore perform the determination of expected resource utilization for each time period on the assumption that the permanently allocated resource will be utilized at that time period. However, it is possible that permanently allocated resources may not be utilized at every time period. In one embodiment, determining the expected resource utilization comprises analysing historical utilization data of each resource zone to determine the expected utilization of permanently allocated resources in the resource zone at each point in time. The historical utilization data comprises information on when each resource was actually used across previous time periods. For example, the activation of/logging on to each workstation may be tracked. The historical utilization data may indicate that the permanently allocated resources may only be utilized for specific time periods (e.g. a certain day of the week). The suggestion engine may therefore mark the permanently allocated resource as being utilized of unutilized for each point in time to calculate the expected resource utilization of the resource zone.

The embodiments described herein assume that if a resource has been allocated for a particular time period, that resource will be utilized at that time period. However, in some circumstances resources may be reserved/allocated but not actually used. For example, the person to which a resource is allocated may be off sick, or may be called away on urgent business, or may change his/her mind about attendance in the building on that day. In an alternative embodiment, the determining a resource utilization can include determine a probability of a resource actually being utilized at the time period, and weight the determined resource utilization in response. In one example, determining the expected resource utilization comprises analysing historical utilization data to extrapolate the likelihood of resources that have been allocated will actually be utilized at the time period. The historical utilization data may indicate the likelihood of the utilization of the resource based on the zone, the specific resource being utilized and the person to which the resource has been allocated.

In one embodiment, the suggestion engine utilizes self-learning algorithms to extrapolate the likelihood of resources that have been allocated will actually be utilized at the time period. The self-learning algorithm utilizes a plurality of parameters that are independent of the environment that will affect the likelihood of whether a resource is likely to be utilized or not. These parameters can include, but are not limited to: an identification of the user that has been allocated the resource, the department of the user, the time period for which that resource has been allocated (e.g. day of the week), additional timing information (e.g. the month or season in which the time period falls), pattern of attendance of the user and/or other users, and seniority of the user.

In addition, the self-learning algorithm utilizes a plurality of parameters that are functions of the environment that will affect the likelihood of whether a resource is likely to be utilized or not. These parameters can include, but are not limited to: historical patterns of actual utilization of the user for specific allocated resources, historical interactions with other users (for example, historical trends may indicate that a user may be more likely to actually utilize an allocated resource if another person or persons have also been allocated resources nearby for the same time period). explicit allocation choices made in the past that diverge from an allocation determined by the suggestion engine (e.g. the system selected Workstation A for allocation but the user changed it to Workstation B), closeness (or predicted closeness) to utilisation objective such as a meeting room or another resource, or user feedback on the produced suggestions.

Each of these parameters (environment independent or dependent) is provided with an associated set of weights (or likelihood modifier) that will apply to the resources. Initially these may start with values seeded from prior model data, such as when the usage is low (i.e. during the early stages of use of the system within an environment). As data volumes grow, the model may move to a machine deep learning model. That is, the parameters may be modified (trained) based on training data acquired during use of the system. In addition, further dynamic parameters stemming from the processing of the training data may be added to the model (the set of weights). In addition, or alternatively, provided sufficient training data, a computational model consisting of multiple processing layers (e.g. an artificial neural network), where the data is represented in multiple layers of abstraction with a variety of goals, may be trained from the training data. Through training, gradual optimization results in new values for the modifiers as well as new modifiers for the inputs (e.g. user/resource/day).

The machine learning model may be trained on a training data set that may comprise many (e.g. millions of) training examples gathered from measuring actual utilization compared to predicted utilization. The training data set may be collected by observing patterns of utilization for a plurality of physical spaces across an extended period of time (for example, the system may receive data relating to thousands to millions of users creating hundreds of bookings per annum each).

In one embodiment, the computer-implemented method further comprises identifying one or more collaborative groups. Each collaborative group comprising a plurality of building occupants as group members, to which resources are to be allocated. The individuals within a collaborative group may have a connection with one another such that resource allocations can be made to optimise collaborations and interactions between the users, and optimise the functionality of shared or proximate resources that have been allocated. For example, multiple members of the same team may wish to physically interact with one during the course of work activities, such as hold meetings, hold in-person discussions with or without printed documentation, physically mark or sign documentation as a group, or interact with physical tools or apparatus. If such members of a group are allocated to resources that far apart (e.g. are on opposite sides of the office), then such interactions require increased movement back-and-forth across the office space to physically interact, putting a burden on physical systems—opening of doors, maintenance of environmental conditions in connecting corridors, increased wear and tear on office equipment. The efficiency of the work tasks conducted by the individuals will be impacted also, with lost time to move to meet others, as well as missed opportunities to collaborate with colleagues who are not physically present.

Furthermore, allocation of resources to different members of a collaborative group on different days will also negatively impact collaboration. Accordingly, the system may be configured to bias suggested resource allocations for members of a collaborative group such that they are allocated at the same or similar time periods. The same time period may be any set of time periods that overlap either completely or partially. The allocation may be for resources in the same overall location or site (e.g. in the same building), but need not be particularly close to each other. Nevertheless, preferably the resources will be spatially proximate to each other within that same overall location or site (as discussed above).

The collaborative groups may be known to the system (e.g. Teams or Departments within the building, or “Friends” lists on software communication platforms), or the groups may be determined by the system based on current or historic allocation of resources. For example, a group of individuals may be observed to historically reserve seats next to one another, or a group of individuals may be observed to have an upcoming meeting in common. The identified collaborative groups may be fixed (e.g. a departmental team), or may be transient in nature (e.g. the group is identified only for the time period of a single meeting that they have in common).

In embodiments that utilise collaborative groups, the suggested resource allocation may be determined such that the suggested resource allocation is an allocation of one or more resources in one or more resource zones for the specified time period such that the resources allocated to the group members are located spatially proximate to each other. For example, in determining the suggested resource allocation, the suggestion engine may identify a particular zone within the building as being for a collaborative group, and preferentially suggest allocation of resources of the zone to members of that group. The identified zone may be identified as an attractor seed, and members of that group that request new allocations are preferentially suggested this zone and resources within this zone for said new allocations. In one embodiment, the optimization weighting for a resource zone may include a collaboration weighting factor. The collaboration weighting factor may be determined based on whether a location or zone is identified as an attractor seed for a collaborative group. If a location is identified as an attractor seed, then the collaboration weighting factor for a resource may be weighted based on its distance to the location (e.g. the weighting factor may be increased as distance decreases). If the zone is an attractor seed, the suggestion engine may increase the collaborative weighting factor for an allocation of a resource within the attractor seed when determining a suggested resource allocation for user that is a member of that collaborative group. The suggestion engine may also reduce the collaborative weighting factor for an allocation of a resource within the attractor seed when determining a suggested resource allocation for a user that is not a member of that collaborative group.

A location may be determined to be an attractor seed if a certain number of members of the group are allocated to resources that are clustered together. A zone may be determined to be an attractor seed similarly if a certain number of members of the group are allocated to resources within the resource zone.

The identification of a location as an attractor seed may be based on input information identifying collaborative opportunities. For example, the input information can include information: identifying the department of members of the collaborative group, identifying the seniority of members of the collaborative group, identifying teams to which members of the collaborative group belong, identifying company policy information and identifying lists of friends of members of the collaborative group. For example, if a collaborative group comprises one or more senior members of staff, a location or area corresponding to the senior staff members' office(s) may be identified as an attractor seed. If a collaborative group comprises members of a certain department, then a location or area corresponding to department-specific resources (e.g. IT resources for the IT department) may be identified as an attractor seed.

Company policy information may include requirements on employee attendance, including a minimum amount of time (e.g. a number of days) that a person or group of people must physically be present in a physical space, and a maximum amount of time that a person or group of people can be physically present in a physical space. Company policies may further specify that the minimum or maximum amounts of time are dependent upon a person's seniority (for example, a junior member of staff may be required to be on site to attend in-person training). The company policy information may also indicate a restriction on attendance on certain days for one or more persons. The company policy information may also specify limitations on resources that may be allocated to one or more persons (for example, some resources may only be allocated to a person identified as having a certain level of experience).

The identification of teams, friends lists of memberships or other groups of individuals can be used to identify a location or area as an attractor seed to improve collaboration opportunities between members of the collaborative group and other individuals. In this embodiment, the suggestion engine identifies one or more other locations that contain existing or predicted allocations for individuals that are members of the same team, friends list or other grouping associated with a member or members of the collaborative group, and one or more corresponding time periods over which those existing or predicted allocations are assigned. The location(s) of the one or more other resource zones may be identified as attractor seed(s) for those time(s). In this embodiment, the optimization weighting comprises a spatial weighting factor. The spatial weighting factor is determined based on the degree of spatial proximity of each resource zone to the one or more other resource zones at those time(s).

As described herein, spatial proximity may be determined by an amount of “time travelled”, which is a measure of how long it takes for a person to travel from one location to another location. This can include walking time, travel time in elevators, time taken to open doors, etc. Information identifying the time travelled between resource zones may be stored at a database accessible by the suggestion engine. When determining the spatial weighting factor for a resource allocation, the suggestion engine may look up the time travelled between the two locations (e.g. a resource and an attractor seed), and calculate the weighting factor in proportion to the time travelled. Alternatively, the spatial weighting factor may be a binary amount (i.e. 1 when the time travelled is below a threshold or 0 when the time travelled is above a threshold).

The attractor seed may further be identified to improve collaboration between members of the same collaborative group. In one embodiment, the attractor seed may additionally be identified as a resource zone in which resources have already been allocated to members of that team, and which has available capacity that can accommodate team members that are not already allocated resources in that zone (including team members yet to be allocated resources, and team members that have been allocated resources elsewhere, but can potentially be reallocated to the attractor seed). By being allocated resources within the same zone, the members of the collaborative group are thus located proximate to one another and their collaboration is improved.

In one further embodiment, the collaborative group members may be suggested allocations of resources for spatial proximity to another resource, zone, room or other part of the building. For example, the collaborative group may be scheduled to use a meeting room for a particular time period. In this embodiment, the suggested resource allocation may be such that the team members are suggested an allocation of resources proximate to the meeting room. In one embodiment, the method further comprises identifying that the group members of the collaborative group have been allocated a communal resource for a specified time period. The suggested resource allocation is determined such that the resource allocations suggested to group members comprise resources that are located spatially proximate to the communal resource. In this embodiment, the optimization weighting may comprise a spatial weighting factor. The spatial weighting factor may be determined based on the degree of spatial proximity of each resource zone to the one or more other resource zones.

This allocation of resources to team members for spatial proximity to a meeting room or communal resource may be achieved through identification of a proximate resource zone as an attractor seed. For example, when the collaborative group is scheduled to use a meeting room for a particular time period, a resource zone that is proximate to the meeting room may be identified as the attractor seed. When the method further comprises identifying that the group members of the collaborative group have been allocated a communal resource for a specified time period, a resource zone that is spatially proximate to the communal resource may then be identified as the attractor seed. In these embodiments, the members of the collaborative group are thus preferentially suggested resources in a resource zone that is spatially proximate to the meeting room and/or communal resource to optimise resource utilization efficiency (e.g. to minimise unnecessary foot traffic to and from the meeting/communal resource).

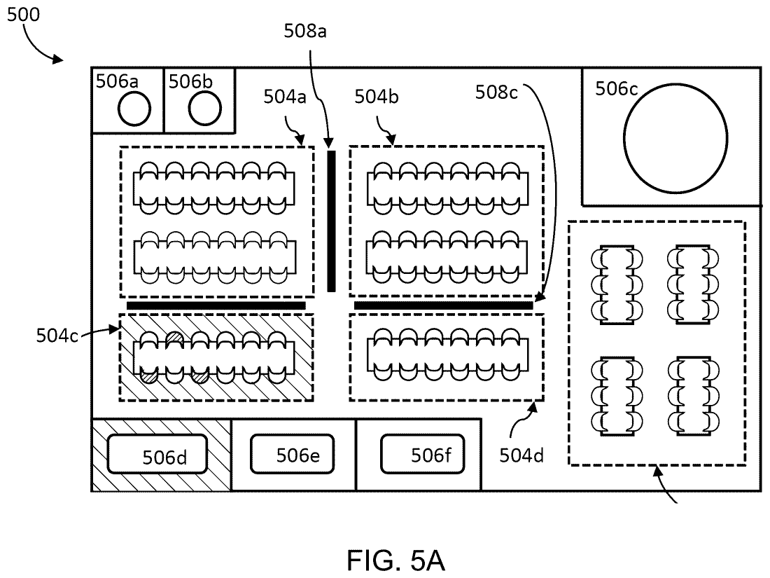

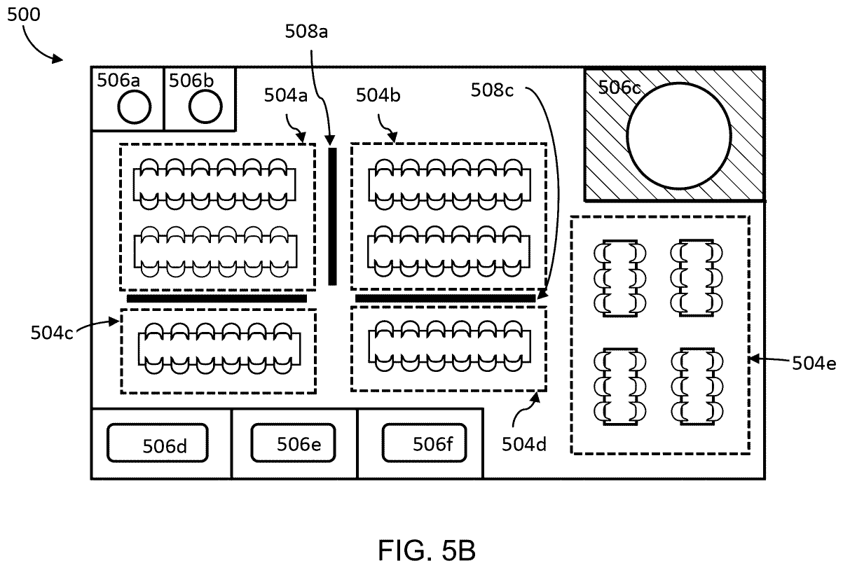

Examples according to this embodiment is illustrated in FIGS. 5A and 5B. FIGS. 5A and 5B shows a floor 500, which contains resource zones 504a-504e and meeting rooms 506a-506f. The workstation suggestion engine would aim to suggest workstations in the zone most proximate to meetings the users are due to attend. In the example of FIG. 5A, a meeting for six people of a collaborative group in Room 506d is planned, and there are already three members of the group with confirmed allocations in resource zone 504c. The suggestion engine would thus identify resource zone 504c as an attractor seed, and preferentially suggest the available workstations in resource zone 504c to the remaining attendees when they book a workstation for the day in question.

The suggested resource allocation may also be selected based on proximity to other, available resources that members of the group may wish to reserve. For example, the suggestion engine may allocate a meeting room to a collaborative group due to the spatial proximity of the meeting room to one or more resource zones with capacity to accommodate all members of the collaborative group. In the example of FIG. 5B, a meeting for 12 attendees is being organized. Meeting room 506c is selected for allocation of group members since it has sufficient resources to cater for all members of the team, but is also proximate to resource zones (e.g. resource zones 504b and 504c) that have available workstations for allocation to its users.

The suggested resource allocation may optionally suggest allocations of resources from a plurality of resource zones to members of the collaborative group where the plurality of resource zones are spatially proximate to one another.

As previously identified, the number of resources being allocated at any one time may be fluid, with different resource zones and different utilization time periods filling up faster than others. This may also be the case with reservations being requested from members of collaborative groups. Without consideration of the reservations coming from each collaborative group, the resource utilization of the final allocation of resources may not be optimised on the collaborative group level (even if the final allocation optimises the resource utilization by keeping overall resource zone occupancy within the specified value range).

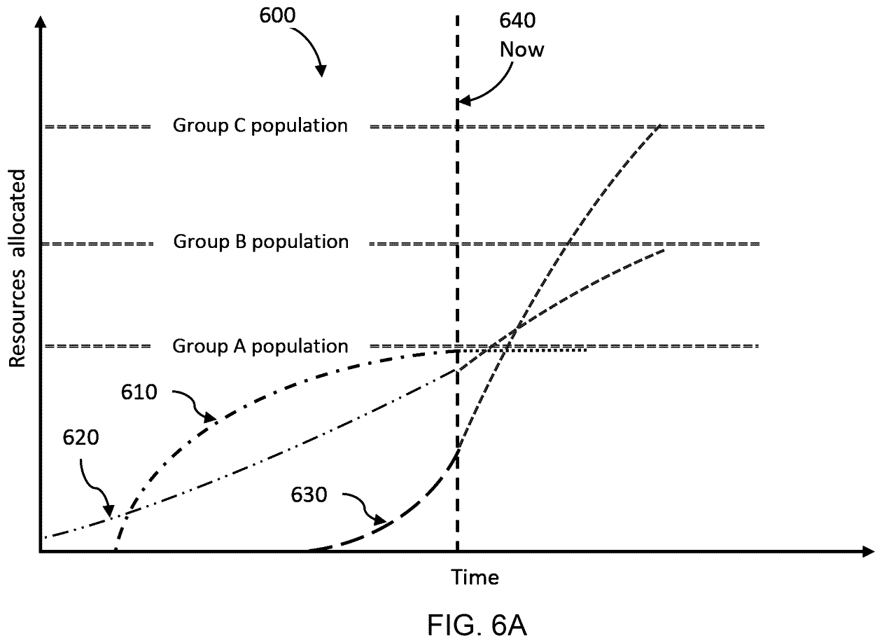

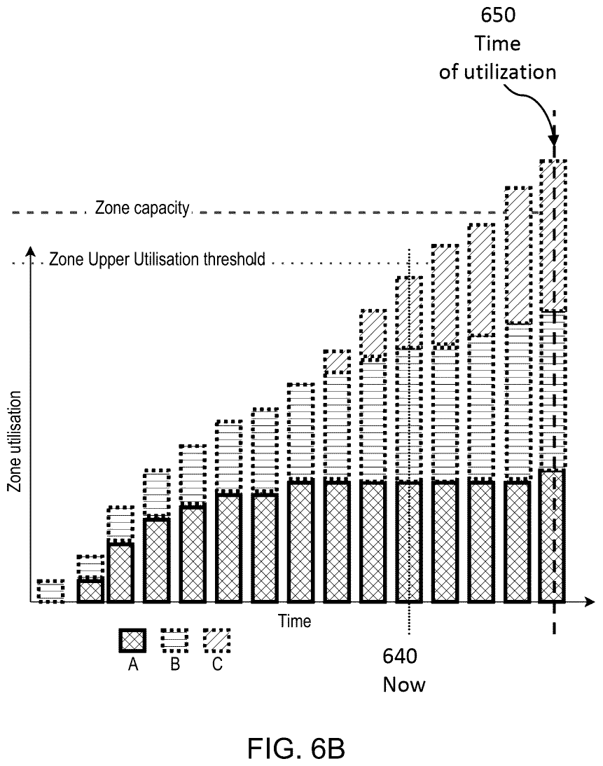

The allocation of resources within one particular zone to members of different collaborative groups is illustrated in FIGS. 6A and 6B. FIG. 6A shows a line graph 600 that illustrates the number of allocations versus time for three groups—Group A (line 610), Group B (line 620) and Group C (line 630). FIG. 6B illustrates a bar chart that illustrates the total number of allocations versus time for each of the three groups A, B and C. At point 640, the time at which the resource utilization is determined, the number of resources that have been allocated to the zone is below the optimum zone capacity. As shown in FIG. 6B, at time period 640, the combined allocated resources across all three groups is below the optimum upper utilization threshold.

However, as shown in FIG. 6A, members of each group are yet to be allocated resources within the zone. Lines 610, 620 and 630 indicate the trend of reservations for each group. Without intervention from the systems and methods described herein, it would be expected for resources to be allocated to exceed the upper utilization threshold, and furthermore there will be members of one or more of the groups that would not be able to obtain a workstation within this resource zone. This is undesirable from resource utilization optimisation at the resource zone level (e.g. maximum allocation of the resources would lead to overcrowding and overburdened environmental systems), but also at the collaborative group level (e.g. one or more groups will have a minority fraction of members allocated to resources outside the resource zone).

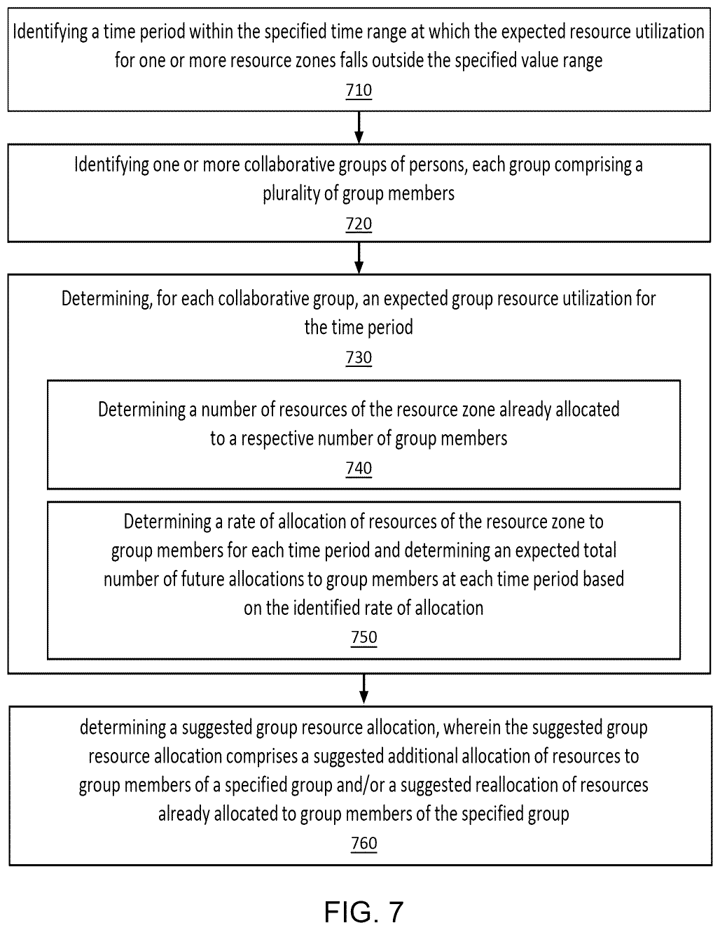

The above-described methods (i.e. determining a suggested resource allocation based on currently allocated resources and on a prediction of future allocation of resources) would be able to optimise the allocation of resources at the resource-zone level, but there may be less than optimal allocations on the collaborative group level. In one embodiment, the computer-implemented method of optimising resource allocation may additionally optimise allocations for one or more collaborative groups. The method is illustrated in FIG. 7.

The method includes identifying 710 a time period within the specified time range at which the expected resource utilization for one or more resource zones falls outside the specified value range. An example is the resource zone of FIGS. 6A and 6B. The method further includes identifying 720 one or more collaborative groups of persons, each group comprising a plurality of group members. Each collaborative group may be a collaborative group as defined above (e.g. fixed or temporary, permanent or transient). As part of identifying each collaborative group, the method includes identifying the total population of each collaborative group. The method further comprises determining 730, for each collaborative group, an expected group resource utilization for the time period. The expected group resource utilization for a group is the resource utilization contribution of that group to the overall group resource utilization. The determining 730 the expected group resource utilization comprises: determining 740 a number of resources of the resource zone already allocated to a respective number of group members; and determining 750 a rate of allocation of resources of the resource zone to group members for each time period and determining an expected total number of future allocations to group members at each time period based on the identified rate of allocation.

For each time period within the specified time range, the suggestion engine can determine the number of resources within the resource zone that have already been allocated to members of each group for that time period, as well as the point in time at which each group member allocation was made. From these determinations, the suggestion engine can determine a function describing the number of allocations to group members against time for each resource zone for each time period. Optionally, the suggestion engine may utilize historical information when predicting future allocations of resources for the resource zone. For example, the suggestion engine may utilize previously observed rates of allocation when determining the allocation-time function.

The expected group resource utilization comprises an indication of the number of resources within the resource zone that have already been allocated to a respective number of group members at each time period, and an indication of the expected total number of future allocations to group members at each time period. The determination of the expected group resource utilization is determined in combination with the overall resource utilization value (the overall resource utilization includes not only the sum of the expected group utilization resource values, but contributions to the resource utilization from allocations to persons not identified as part of any collaborative group).

The method further includes determining 760 a suggested group resource allocation. The suggested group resource allocation comprises a suggested additional allocation of resources to group members of a specified group and/or a suggested reallocation of resources already allocated to group members of the specified group. The suggested group resource allocation is an allocation of one or more resources in one or more resource zones for a suggested time period within the specified time range. In this embodiment, the suggestion engine identifies one group (or more than one group) to steer away from the one or more resource zones that are expected to exceed the maximum utilization threshold. For future allocations requested by members of this group, the suggestion engine will suggest one or more alternative resource zones at the same time period or an alternative time period, or the same resource zone at a different time period. The suggested resource allocation is determined such that after allocation according to the suggested group resource allocation, the expected resource utilization of the one or more resource zones for the suggested time period is within a specified value range.

Each suggested group resource allocation is the suggested resource allocation presented to members of a respective collaborative group. In one embodiment, the suggested group allocation is a suggested resource allocation for members of a group based on an optimization weighting that includes a group weighting factor for each allocation of resources.

A group weighting factor is applied to resource allocations to be suggested to each member of collaborative groups to make it more likely or less likely that the suggestion engine will suggest allocations of resources to members of each group. For example, the group weighting factors for resource allocations for the specified group will be different to the group weighting factors for the other collaborative groups. In this case, the group weighting factors will be higher for allocations of resources in the one or more alternative resource zones, such that the suggestion engine suggests an allocation of resources in the one or more resource zones to members of the specified group.

The group weighting factors may be different for different members of the collaborative group to make it comparatively more likely that a suggested resource allocation will be presented to certain members of the group. For example, the group weighting factor for the allocation of resources in the one or more alternative resource zones may be high for group members yet to be allocated resources, but low for group members that have already been allocated resources. This has the effect of only steering new allocations to the new resource zone. Similarly, the weighting factors for resource allocations may be high for a subset of group members that have already been allocated resources, such that only a fraction of already allocated resources are suggested to be reallocated by the suggestion engine.

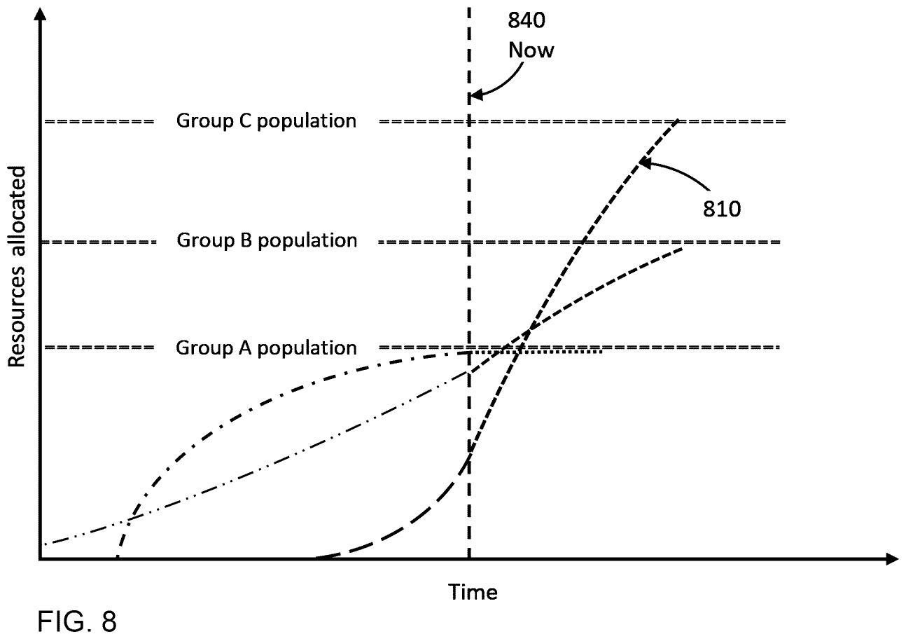

In one embodiment, the specified group is the group having the greatest rate of allocation of resources for a resource zone and/or the lowest number of resources already allocated to the resource zone. Considering the example again of groups A, B and C of FIG. 6A, at the point in time 640 at which the predicted resource utilization is being determined, group C can be identified as the best candidate for the following reasons:
The rate of new reservations is very high but only a small subset of the group has already been allocated resources. Thus, allocation and reallocation for members of group C will have the greatest effect on overall resource utilization. As shown in FIG. 8, group C has the greatest potential growth 810 in future allocation of resources after time point 840.
Group A only has a very small potential, as the vast majority of its members have already had resources allocated. Steering away any new booker from that group away would not only have minimal effect on the overall resource utilization of the zone, but would also lead to isolation of small numbers of the group from the group as a whole and lead to less than optimal collaborative resource utilization.
Group B still has a fair proportion of its users to be declared, and these yet to be allocated members may be allocated away from the current resource zone to alternative zones or time periods. However, even if the remainder of group B is steered away, the zone does not have enough unallocated resources to accommodate all members of group C without allocated resources. Allocating group B away would also require at least partial allocation of group C away as well, leading to less than optimal collaborative group resource utilization across all groups. By contrast, if new resource allocations requests from group C are steered away from the zone, the resource zone will have sufficient unallocated resources to allow for all remaining members of group B to be allocated resources within the zone.

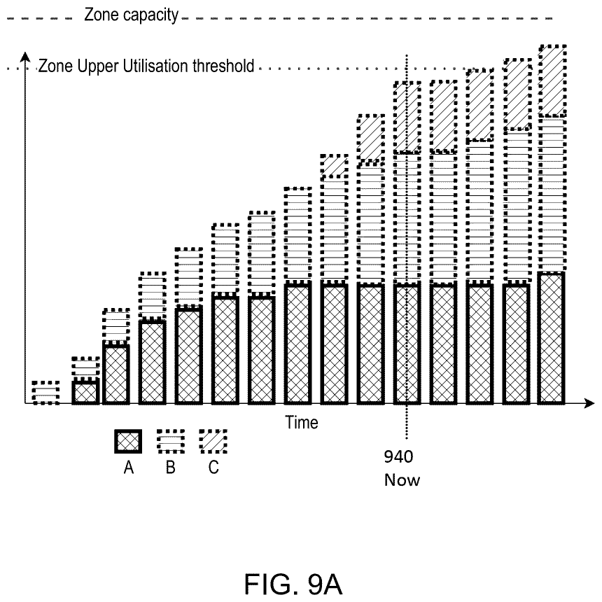

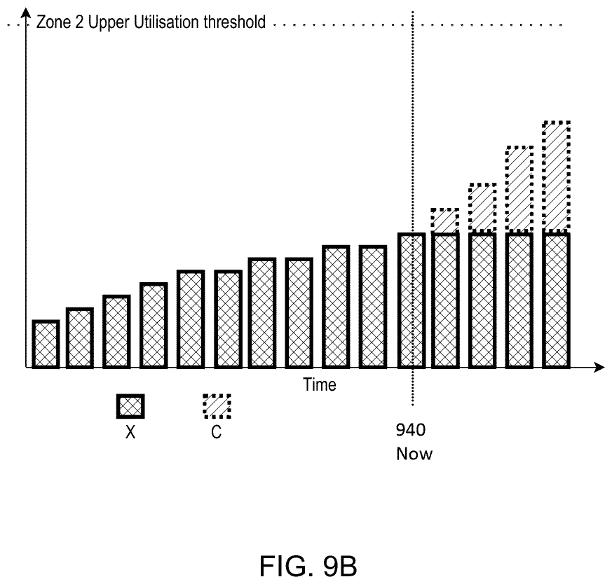

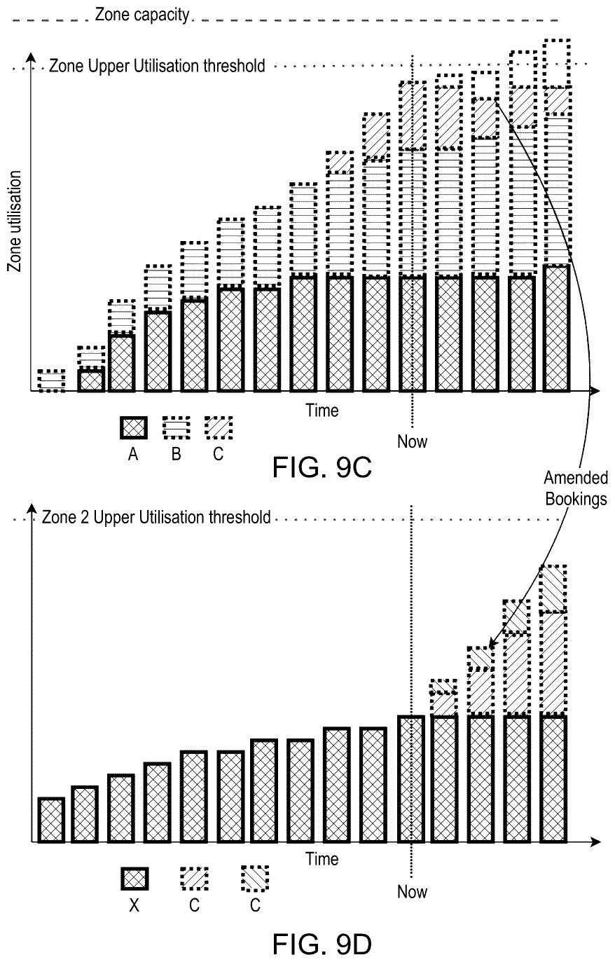

FIG. 9A illustrates the effect of steering future allocation requests from group C away from the resource zone. The number of allocations made to group C at the present time period 940 remains constant as resources continue to be allocated to group A and group B. FIG. 9B illustrates an alternate zone into which the members of group C have been allocated in response to future requests for allocation of resources. The alternate zone may have already allocated resources X that vary in time, but may not be attributed to any one group. The suggestion engine may select the alternate resource zone by determining the remaining members of group C to which resources are to be allocated and identifying a resource zone that has sufficient unallocated resources to allocate to the remaining members of Group C. The allocation of resources for the remaining members of group C may be for the same time period as the already allocated resources for group C, and the alternate resource zone may be a resource zone that is spatially proximate to the resource zone for the already allocated resources for group C, to improve collaboration for members of group C.

The suggested allocation of resources as shown in FIGS. 9A and 9B provides more optimised collaboration and collaborative resource utilization, but overall utilization of the group is less than optimal. As shown in FIG. 9B, the final total resource allocation is above the maximum utilization threshold. The suggestion engine may seek to optimise the resource utilization in the resource zone by also steering away new allocation requests for remaining members of group B, as described above. In the alternative, the determined suggested allocation may include a suggested reallocation for the specified group (in this example, group C).

As shown in FIGS. 9C and 9D, the system may select one or more already booked resources and determine a resource allocation away from the existing resource zone such that the overall resource utilization for the existing zone is brought below the upper utilization threshold. The system may select the alternate resource zone (i.e. the zone into which the future group C resource allocations are to be made) as the suggested zone for the reallocation of resources for members of group C that have already been allocated resources. In this manner the collaborative opportunities and collaborative resource utilization are optimised across the multiple zones.

This reallocation process may be combined with a process to manage under-utilized resource zones within the building. For example, the suggestion engine may determine that the expected resource utilization is below the lower optimum threshold for an underutilized zone at a given time period. The suggestion engine may also determine that the resource utilization for other zones is determined to be within the optimal utilization value range but without enough vacancy to allow for the population to be comfortably relocated from the underutilized zone. The system may then identify the underutilized zone as the alternate resource zone for future allocations of the collaborative group. Future allocations may thus come and fill the gap in order to achieve a more even occupancy distribution. In this embodiment, the system thus manages to optimise the overburdened resource zone containing the expected allocations for groups A, B and C, but also optimise the underutilized resource zone by directing future bookings to that resource zone.

However, this embodiment not simply about looking at the occupancy levels, but looking at the trends in rate for new reservations for each zone for each time period and the capacity for the predicted future allocations. A resource zone might not be identified as underutilized (and thus identified as the alternate resource zone) if it is predicted that future allocations will bring the resource zone within the optimise utilization value range. Also, the underutilized resource zone might have been identified by the suggestion ending as a zone for preferential suggestion of resource allocation as a result of determining a suggested resource allocation (e.g. if the zone has 50 seats that is under populated for a given day, but the system estimates there are still 40 people that are yet to make their reservations, action should be needed if the determination process for the suggested resource allocation as described before has ensured that these upcoming bookings are routed to this zone preferentially).

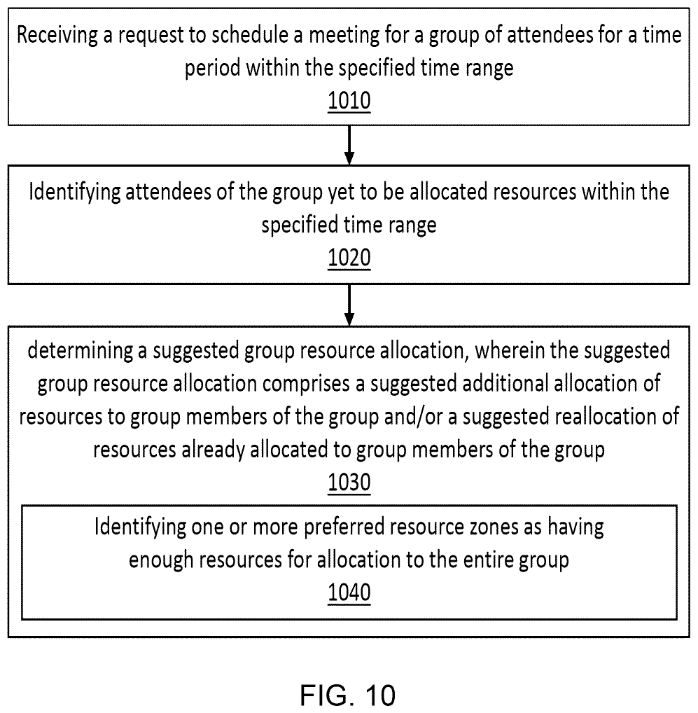

In one embodiment, the suggestion engine is configured to proactively determine a resource allocation to facilitate a group of individuals, such as a collaborative group, to optimise collaboration and optimise resource utilization. FIG. 10 illustrates this embodiment, in which the computer-implemented method further comprises receiving 1010 a request to schedule a meeting for a group of attendees for a time period within the specified time range. The group in question may be a collaborative group as defined above. The request may come from a single individual, such as a team leader or member of the group, or from a system administrator or other individual. The method further comprises identifying 1020 attendees of the group yet to be allocated resources within the specified time range.

The method further comprises determining 1030 a suggested group resource allocation, wherein the suggested group resource allocation comprises a suggested additional allocation of resources to group members of the group and/or a suggested reallocation of resources already allocated to group members of the group. The determining 1030 a suggested resource group allocation comprises identifying one or more preferred resource zones as having enough resources for allocation to the entire group. The suggested group resource allocation is an allocation of one or more resources in the one or more preferred resource zones for a suggested time period within the specified time range, such that after allocation according to the suggested group resource allocation, the expected resource utilization of the one or more resource zones for the suggested time period is within a specified value range.

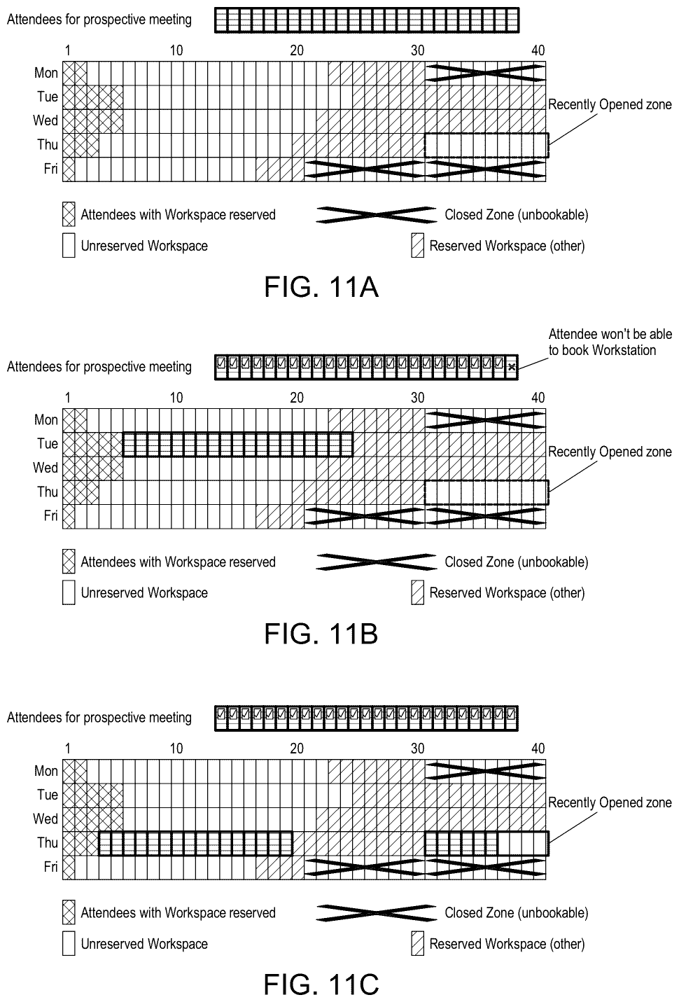

The determination of an example suggested allocation of resources for a group is described below in connection with FIGS. 11A-11C. FIG. 11A schematically shows a schedule of allocated and unallocated resources for one or more resource zones in a building. In this case, Monday through to Friday is illustrated, with a row of resources shown for each day. The resources are illustrated as either being able to be allocated, but currently allocated, being able to be allocated, but currently unallocated, or not being able to be allocated (the resource is in a closed zone). The allocated resources include resources allocated to members of the group as well as resource allocated to other building occupants.

A department head wishes to schedule a meeting for his/her department, which is made up of 25 group members. An optimised allocation of resources is such that all of the group members are allocated resources on the same day of the week, but also that resources are allocated from resource zones such that the overall resource utilization on each day is less than the optimum resource utilization threshold. Of the 25 group members, 10 have already been allocated workstations for one or more days during the week, but 20 have not yet been allocated a workstation at any point during the week. Of the 10 already allocated, the suggestion engine can establish that 2 would be on site on Monday, 5 would be on site on Tuesday, 5 on Wednesday and 3 on Thursday and only 1 on Friday.

When purely assessing a candidate day based on already allocated resources, Tuesday could be the best candidate since five team members are already scheduled to work that day. However, the system can assess that the resource utilization density is already quite high for that day, and that there are insufficient resources to accommodate the extra 20 attendees in the same or nearby zones on that day. As shown in FIG. 11B, this would cause uncomfortable levels of occupancy density (100%), and furthermore at least one attendee not being able to obtain a workstation for the day. Thus, resource utilization would not be optimal, and collaboration between team members would also not be optimal.

As a result of performing the computer-implemented method of FIG. 10, the system could suggest Thursday as a better option. Thursday includes a resource zone with available capacity for all of the attendees, even though only three members of the team have already been allocated resources for that day. For example, the available resources include resources in a resource zone that has only recently been opened, which could accommodate the all group members (including these already on site for that day) for the meeting as well as keeping the overall occupancy within optimal resource utilization limits (in this case 90% utilization, 10% seating remaining available).

The suggested time and place would be ideal fit for capacity of the booking (in the example of FIGS. 11A-11C resources that can accommodate 35 people). The suggested time and place would also cater for the ability to accommodate all or a great majority of the attendees in workstations in resource zones neighbouring the meeting room, thus giving the best collaborative density solution.

In addition, the suggestion engine can determine the availability of additional resources or an additional resource zone or resource zones that can accommodate all members of the group. The suggestion engine can then preferentially select a preferred resource zone based on the availability of the additional resources or additional resource zone(s). For example, the system could determine that there are two time periods that have sufficient available resources to accommodate both members, but only one time period also has available a meeting room of sufficient capacity, the suggestion engine will determine a suggested allocation of resources for the time period that includes the available meeting room.

As a result of the determination of the suggested allocation, the suggestion engine may create an “attractor seed”, for future reservations. This means that when members of the group who have yet to be allocated resources make a request for resources, those attendees are preferentially suggested a resource on the determined optimum day and place. The suggested resource is also in the vicinity of any meeting room that is reserved on that day, thus helping bring the spatial collaboration density within the optimal range on that day.

The above described examples relate to the optimization of resource allocation for newly allocated resources. As mentioned above, the suggested resource allocation may include a reallocation of already allocated resources. In this case, the computer-implemented method further comprises identifying attendees of the group of attendees that already have resources allocated to them within the specified time range; and determining a revised group resource allocation, the revised group resource allocation being an allocation of one or more alternative resources in one or more resource zones for the attendees that have already been allocated resources for a time period that is not the suggested time period. Thus, the suggestion engine can reallocate resources from alternate time periods to the newly determined optimal time period. In the example of FIGS. 11A-11C, those users that have already been allocated workstations on Monday-Wednesday and Friday will be allocated alternative resources to those already allocated. The system will notify these few individuals that were already reserved that the opportunity exists for them to trade their less suitable booking with a new one that would fall in the right resource zone and day (with the option to simply accept a suggested workstation that the system has elected for them or an opportunity to review and amend the suggestion). Optionally, this suggestion may only occur on days prior to the day of the booking (e.g. the reallocation of a resource may not occur on the day that the resource is actually scheduled).

In the alternative to notifying and inviting the user to accept the allocation/reallocation, the allocation/reallocation of resources may be performed automatically by the system in response to the determination of the suggested resource engine. The members of the team may then be notified of the change in their allocation.

This mechanism works for both ad-hoc meetings (like in the example where it's a one-off meeting at the request of a department team leader) but may also apply to the creation of recurring bookings (“Weekly team meeting” etc . . . ). In this embodiment, the system creates a longer-lived attractor seed that, over time, will help in the smoothing of the utilization of spaces and the overall collaborative efficiency. The identification of a suitable resource zone and time period during the specified time range will take into account determined resource utilization over recurring periods. Thus, when selecting the time and date for the recurring meeting, the organizer can aim for a day in the week that may not elicit optimal attendance for the first occurrence (next Thursday), but will over time act as an attractor for team members to be present on the day.

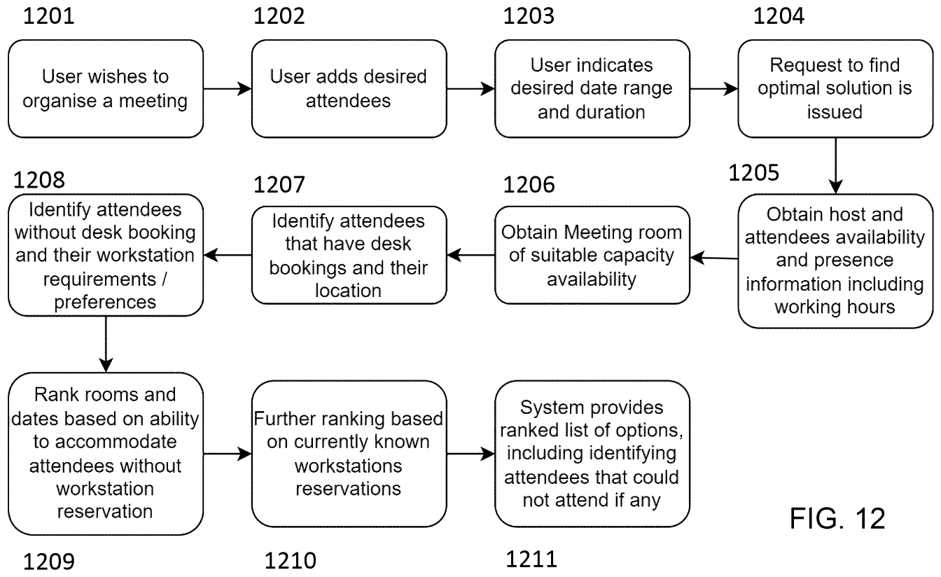

An example process to book a meeting for a group of uses is illustrated in FIG. 12, for which the above systems and methods may be deployed. The process begins at 1201 with a user wishing to organise a meeting. The user then adds 1202 desired attendees to the request for the meeting, following which the user indicates 1203 a desired date range and duration. The desired date range is the specified time range (for example, a week). The request to find an optimal solution is issued 1204 (i.e. the user communicates the request to the suggestion engine). Next, the process obtains 1205 host and attendees availability and presence information including working hours. Such information may be, for example, the user preferences indicates previously and is stored at the data storage repository in communication with the suggestion engine. The suggestion engine determines the optimal solution based on the user preferences. For example, the suggestion engine may determine from the working hours that the majority of the team is unavailable for a certain time period, and thus will not suggest an allocation of meeting room or resources within that time period. Additionally, the suggestion engine may prioritise certain team member preferences or availability. For example, one of the team members is scheduled to be presenting at the meeting, so that team member's availability is prioritised when determining the optimal solution.

The process then obtains 1206 a meeting room of suitable capacity and availability. The process then identifies 1207 attendees that have desk bookings and their location (i.e. those team members with already allocated resources and where those resources are). The process then identifies 1208 attendees without desk bookings (i.e. those team members for which resources have not yet been allocated) and their workstation requirements/preferences. The process then ranks 1209 rooms and dates (time periods) based on ability to accommodate those team members who have not yet had resources allocated to them. Optionally, the system may further rank 1210 the suggested resource allocation for the team members based on the already allocated resources (e.g. may rank higher available resources that are spatially proximate to resources that have already been allocated). Finally, the system provides 1211 the ranked list of options to the attendees. This may be a proactive suggestion to team members (e.g. receipt of an email or push notification), or may be done in response to a later request from a team member when that team member submits a request to reserve a resource. Each team member (and the user making the request, if that user is not already a team member) may also be provided with a notification identifying team members who are not able to attend the scheduled meeting.

Optionally, the resource zones present in the system may have a status indicating whether the zone is “open” or “closed”. If a zone is open, resources within that zone may be allocated to building occupants, and the suggestion engine is able to determine a suggested resource allocation that includes the resources of that zone (with the exception of any resource that is permanently allocated). If a resource zone is closed, then the resources within that zone cannot be allocated to building occupants, and a suggested resource allocation determined by the suggestion engine cannot include the resources of that zone. The “open” and “closed” status of resource zones may be indicated at each tier level of resource zone. Composite resource zones may thus have an “open” or “closed” status, meaning each resource zone within that composite resource zone will also be identified as “open” or “closed” respectively. In one embodiment, the suggestion engine may create exceptions in which one or more resource zones within a composite resource zone may be identified as an excepted zone, which is marked as “open” or “closed” independently of the status of the composite resource zone. Any changes in status of composite resource zones will therefore not affect the status of any excepted resource zones that form part of the composite resource zone.

If a zone within a building has a closed status, then energy consuming facilities associated with the resource zone (e.g. lighting, air conditioning, air filtration) may be turned off or toned down. For example, the method may include turning off or lowering power to a part of an environmental system configured to change an environmental condition of each closed zone. Furthermore, resources present within the closed resource zone may also be turned off or the power supplied thereto may be lowered/toned down—for example, workstations, printers or videoconferencing facilities may be powered off or placed on standby. Selected closure of zones may thus be used to optimise allocation of resources from an occupancy management and energy efficiency standpoint.

In one embodiment, if the suggestion engine identifies that any open resource zones for which there are currently no allocations (i.e. are empty resource zones), and the predicted future allocations can be accommodated without allocations to the identified empty resource zones, the suggestion engine may change the status of that resource zone from “open” to “closed”. Similarly, the suggestion engine may identify one or more under-utilized resource zones for which there are existing allocations, but as part of the resource allocation optimization method determines a suggested resource allocation that includes a reallocation of all existing away from the one or more of the under-utilized resource zones. The suggestion engine may identify the one or more of the under-utilized resource zones as candidates for closure. The identification of resource zones for closure may be performed at any tier level of resource zones; the suggestion engine may thus identify one or more composite resource zones as candidates for closure. The suggestion engine may change the status of the one or more under-utilized resource zones to “closed” to prevent further allocations, and then suggest the reallocation to the persons who have resources allocated to the under-utilized resource zone. Once all already allocated resources have been reallocated, the system may then power off or power down the closed resource zones at the time period. Alternatively, in response to identify the one or more of the under-utilized resource zones as candidates for closure, the suggestion engine may change the status of the one or more under-utilized resource zones to closed, remove the existing allocation or reallocate the existing allocations without confirmation from the user and then power down the closed resource zones at the time period.

The suggestion engine may also determine that one or more closed resource zones are candidates for opening as part of the optimization of resource utilization. In one embodiment, the suggestion engine may determine that the number of currently open resource zones do not have capacity to accommodate all expected resource allocations for the time period. The suggestion engine may also determine that there is no possible resource allocation that would result in the resource utilization of every group being within the specified value range. In response, the suggestion engine may change the status of one or more resource zones from “closed” to “open”, thus freeing up more resource capacity for allocation as part of the optimization method. The suggestion engine may itself change the status of the resource group, or the suggestion engine may request that a facilities manager or other administrator authorise the change.

In one embodiment, the suggestion engine may open one or more resource zones as part of the process determining suggested group allocation of resources for collaborative groups, as described above in connection with FIGS. 6A-9D. In this embodiment, the method of optimizing resource utilization further comprises identifying one or more closed resource zones, each closed resource zone comprising a plurality of resources that are not available for allocation. The step of determining a suggested group allocation further comprises opening the one or more closed resource zones to create one or more opened resource zones such that the plurality of resources within the one or more opened resource zones are available for allocation; and identifying the one or more opened resources zones as the one or more resource zones of the suggested group resource allocation. Thus, in response to selecting a specific collaborative group for to steer toward an alternative resource zone, the suggestion engine may open a previously closed zone to accommodate the new allocations and reallocations for that collaborative group.

This may be in the circumstance where resources zones that are currently open do not have capacity (total capacity or capacity within optimum resource utilization thresholds) to accommodate new allocations and/or reallocations of the collaborative group. Alternatively, the suggestion engine may open a closed resource zone that is spatially proximate to the resource zone that already contains allocations for the collaborative group, thus optimising collaboration opportunities. In addition, or alternatively, the suggestion engine may also identify a closed resource zone that is spatially proximate to another resource or resource zone that has been allocated to the group or group members (e.g. a communal resource or a meeting room).

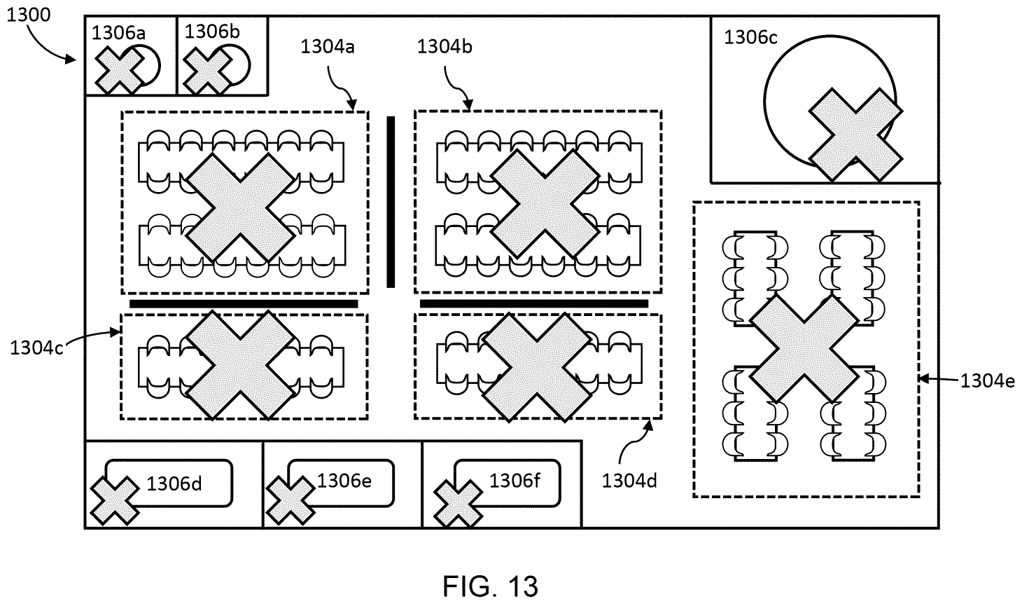

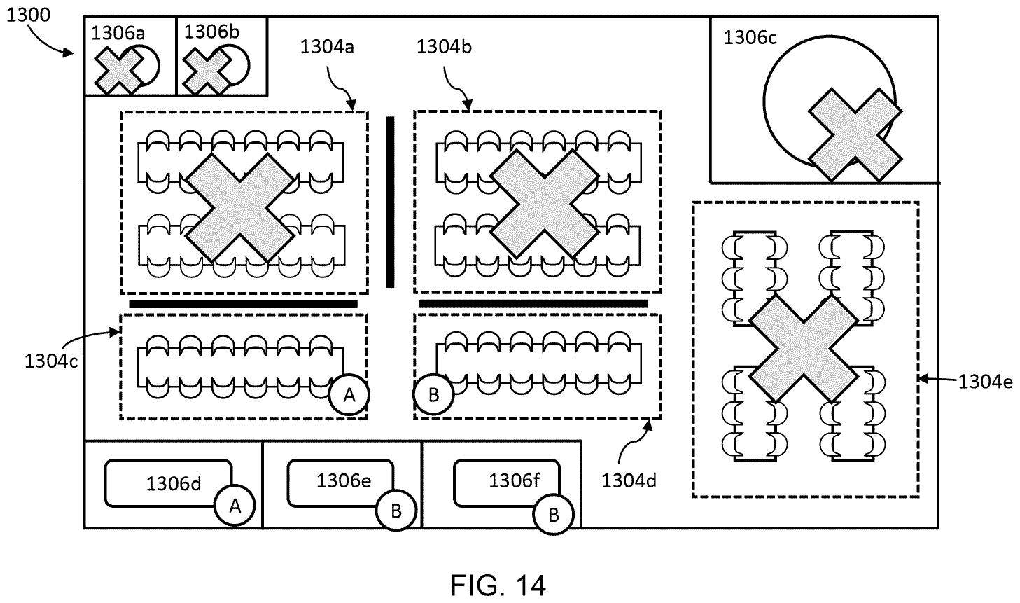

FIGS. 13 and 14 illustrate an example of the opening of resource zones of a floor to provide additional resource allocations in accordance with the embodiments described above. FIG. 13 shows a floor 1300 that has a plurality of resource zones 1304a-1304e and a plurality of meeting rooms 1306a-1306f. On this floor 1300, all resource zones and all meeting rooms have been initially been marked as “closed” (as illustrated in FIG. 13).

The suggestion engine may then receive a request or requests for allocation of resources within the building. These requests may be a request for meetings as described above, or be a request or requests for resources from individual(s) unaffiliated to a collaborative group, or may be a request or requests for resources from a collaborative group. The suggestion engine may determine that the building does not have enough allocatable resources to fulfil the request (either all the resource zones are currently closed, or the resource zones on other floors in the building are unable to accommodate the request within the resource utilization optimisation value range). The suggestion engine may then suggest or enact the opening of zones previously closed off. Once a new zone is open, the system will also determine the suggested resource allocation so that the newly opened zone is suitably populated. In the example of FIG. 13, the suggestion engine may suggest or enact the opening of any one of zones 104a-104e.

In one embodiment, the opened zone functions as an attractor seed as identified above, in which resources in the newly opened zone is preferentially suggested to a collaborative group or other group of individuals when further requests are received. The suggestion engine may also simultaneously open multiple previously closed resource zones such that multiple collaborative groups may be allocated resources across these resource zones in the manner previously described. These multiple resource zones to be opened may be selected to be spatially proximate to one another to improve resource utilization and collaborative utilization. The suggestion engine may also open previously closed meeting rooms for allocation to a collaborative group in response to a request or requests from members of the collaborative group. The opened resource zones may be selected to be spatially proximate to the opened meeting room(s) to improve resource utilization and collaborative utilization and members of the collaborative groups are preferentially directed to the zone that is now made available.

FIG. 14 shows an example of recently opened meeting rooms in accordance with the above embodiment. In the example of FIG. 14, two collaborative groups (group A and group B) are in need of meeting rooms and related workspaces. In response to this need (identified by means of a request or requests to the suggestion engine), the suggestion engine has opened zones 1304c and 1304d, and opened meeting rooms 1306d, 1306e and 1306f. Meeting room 1306d has been opened for group A, and zone 1304c (spatially proximate to meeting room 1306d) has been opened as an attractor seed for reservations for members of group A, and members of group A will be preferentially offered workstations in zone 1304c in response to a request for allocation. Meeting rooms 1306e and 1306f have been opened for group B, and zone 1304d (spatially proximate to meeting rooms 1306e and 1306f) has been opened as an attractor seed for reservations for members of group B, and members of group B will be preferentially offered workstations in zone 1304c in response to a request for allocation.

The above described embodiments include the suggestion engine reallocating resources that have already been allocated, such that overall utilization is brought down into optimal levels. This reallocation may be done to optimise allocation for groups, such as collaborative groups (as described above in connection with FIGS. 9C and 9D), or groups of people scheduled to be attending a meeting (as described above in connection with FIGS. 10 and 11A-11C). These are example implementations of a peak management process and/or a trough management process performed by the suggestion engine. In the peak management process, the system will pro-actively communicate with individuals that could benefit from amending their reservations away from times of peak demand. In a trough management process, the will pro-actively communicate with individuals that could benefit from amending their reservations away from times of low demand. Peak and trough management will benefit the users that are being reallocated, but also will benefit the overall resource utilization of the system (e.g. optimising environmental control).

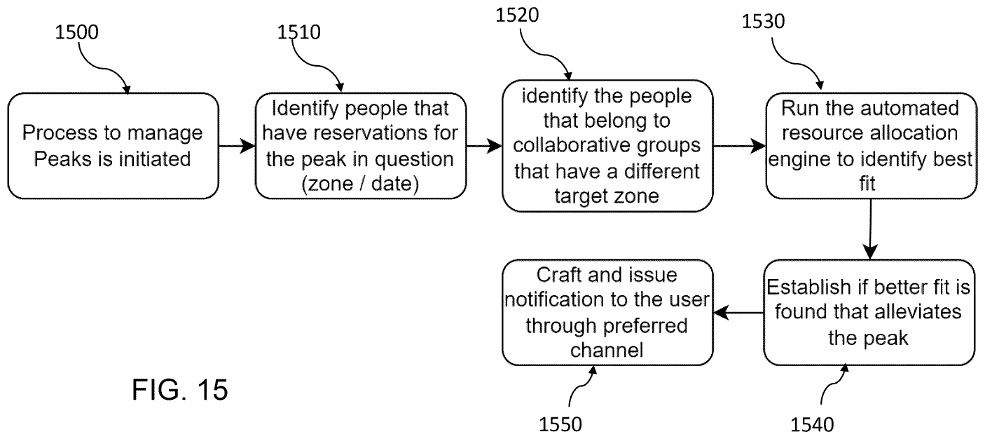

One embodiment of peak management process is shown in FIG. 15. The process begins with the initiation 1500 of a process to manage peaks. This may be done periodically, or in response to a trigger (such as a request to book a meeting or a request for allocation of resources). The process them identifies 1510 people that have reservations for the peak in question (i.e. identifying the allocated resource and the zone to which they belong at the time period of the peak). The process may then identify 1520 collaborative groups of people, including identifying the people that belong to collaborative groups that have a different target zone. With this step, the process seeks to identify the distribution of people within each collaborative group across not only the resource zone experiencing the peak, but all other resource zones. The process then runs 1530 the automated resource allocation engine to identify best fit—i.e. the process determines a suggested resource allocation and suggested group resource allocations in accordance with the embodiments described above. The process then establishes 1540 if a better fit is found that alleviates the peak—i.e. the process determines that the determined suggested resource allocation is the most optimal allocation tin terms of overall resource allocation but also collaborative opportunities for the group members. Finally, the process includes crafting and issuing 1550 a notification or notifications to the persons identified in 1510 through a preferred communication channel (e.g. email or in-app notification).

In a trough management process, determining the resource utilization includes identifying troughs where utilization density is either low (below threshold) or trending towards the lower threshold. The trend toward the lower threshold may be determined by determining a rate at which allocations for a time period are cancelled or reallocated away. If the total expected resource utilization (including currently allocated resources and predicted future allocation of resources) is below threshold, then the system can issue a notification to suggest reallocation in accordance with the embodiments described above.

One aim of the trough management process may be to reduce allocations in an under-utilized zone to a zero level, at which point the under-utilized zone may be closed. Accordingly, in one embodiment, the method further comprises, in response to determining that the expected resource utilization at the identified time period is below the minimum utilization threshold of the specified value range, the steps of identifying each of the one or more resource zones having the resource utilization below the minimum utilization threshold as an underutilised resource zone; and closing each underutilized resource zones such that the resources of the underutilized resource zone can no longer be allocated. As described above, the closure of resource zones allows for the turning off or toning down of energy-consuming facilities or the resources of the zone.

After the zone has been closed, a notification may be delivered to a designated individual, called the Scheduler, notifying him/her of the zone closures. The Scheduler may then communicate with the one or more persons who currently have resources allocated in the closed zone. For example, the Scheduler would be presented with a notification for “zone closure” with the list of individuals and their bookings that are occupying the closed zone on the time period/day in question. The list would include proposed alternatives for each individual reservation, based on the determined suggested resource reallocation as previously described. The Scheduler would then have the option to act on the change himself (accept the reallocation on behalf of the individuals), which would trigger notifications to the individuals of the change having occurred. The Scheduler may alternatively initiate notifications to the individuals presenting them with one or more resources according to the suggested resource reallocation. The individuals may be provided with a grace period in which they are requested to make the change, after which the default proposed option would be automatically selected (e.g. the highest ranked resource when the resources are provided in a list). The Scheduler may alternatively take no action (or possibly engage these individuals directly outside of the system to achieve the changes desired). The involvement of the Scheduler is optional—the system may automatically issue the relevant notifications or trigger the reallocation itself with or without a grace period.

The system may delay powering off or powering down of the energy-consuming facilities or resources for the closes resource zone(s) until all of the resources have been reallocated, or the system may initiate powering off or powering down at the same time as the closure of the resource zone(s).

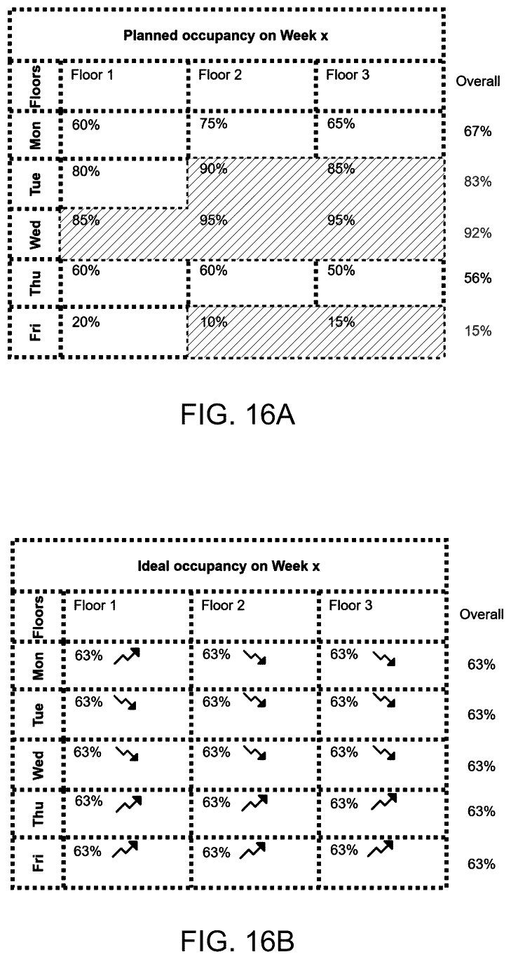

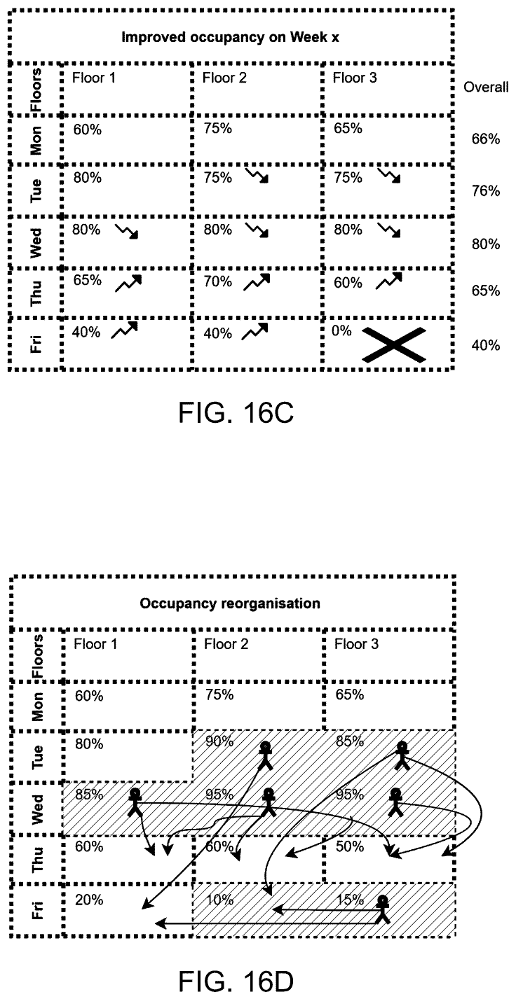

Examples of the peak and trough management process is shown in FIGS. 16A-16D. The examples consider a building with three floors (where a floor is an example of a resource zone, and each floor is assumed to be identical for simplicity here). For a given week, the floors have the expected resource utilization (comprising both existing allocations and predicted future allocations) as shown in FIG. 16A. For this example, the optimum resource utilization range has a lower threshold of 20% and an upper threshold of 82%.

As seen in FIG. 16A, there uncomfortable peaks for two time periods (Tuesday and Wednesday) where the expected resource utilization breaches the higher threshold, and uncomfortable troughs (Friday) where some floors are grossly underoccupied. These are not desirable for various reasons, including employee experience (neither a crowded office nor a deserted office is enjoyable), energy management (overcrowding leads to climate control system having to operate more intensively and consume more energy, and low utilization means that the cost and energy impact of maintaining heating/cooling/lighting per person count is much higher), and air quality (overcrowding leads to poorer air quality and—if present—related control systems having to operate more intensively.

An ideal state would be even utilization across the entire duration and portfolio. This is illustrated in FIG. 16B. However, this is not realistic in a workplace where flexible working is encouraged.

An example desired state for occupancy may be a resource utilization according to FIG. 16C, where occupancy levels are kept in the optimal zone and possibly distributed over a smaller real estate footprint through zones (in this case floor) closure. The overall use (building level) is measured as percentage utilization of the open resource zones (e.g. floor 1 and floor 2 on Friday in FIG. 16C).

Through providing suggested resource allocations that includes suggested additional allocations and suggested reallocations, the users of the system will be prompted to accept resource allocations that results in a more desirable overall resource utilization. An example optimal resource allocation includes a resource reallocation as shown in FIG. 16D. In this example, users in each of the suboptimal floors on Tuesday, Wednesday and Friday are provided suggested reallocations to alterative floors on Thursday and Friday. The most optimal solutions involve providing recommended allocations beyond a single individual—e.g. the identification of groups of people such as collaboration groups and suggesting additional resource allocations or reallocations to members of this group.

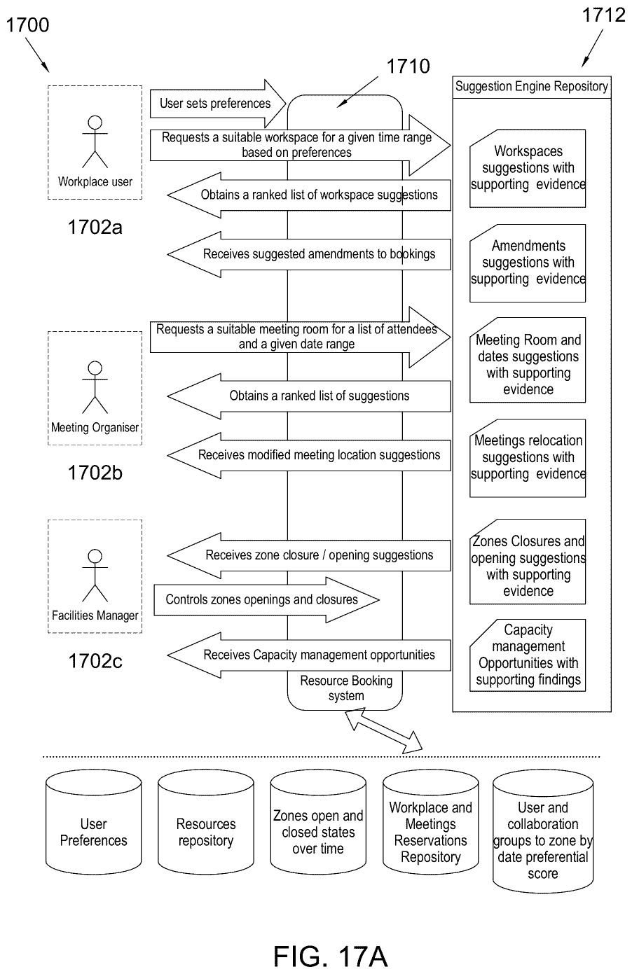

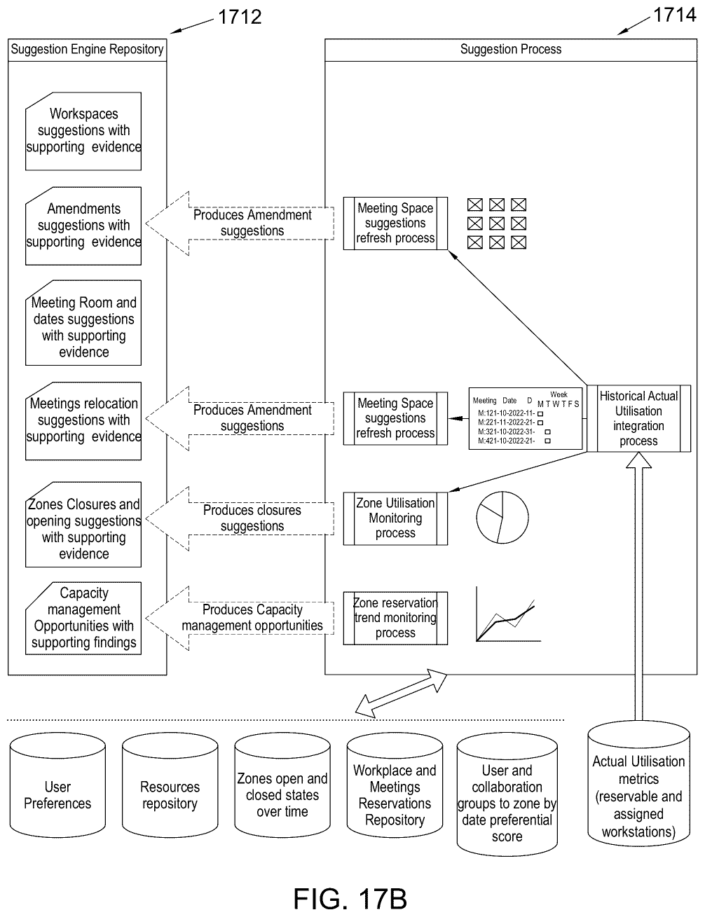

FIG. 17 illustrates an example system 1700 for determining suggested resource allocations. The system comprises a resource booking system/suggestion engine 1710. The suggestion engine 1710 is configured to receive, process and provide responses to persons 1702 in accordance with the embodiments described above. As shown in FIG. 17, the suggestion engine is configured to receive from a workplace user 1702a a request for suitable workspace for a given time range. This request may be based on user preferences, which may also be provided by the user to the suggestion engine. The suggestion engine 1710 may communicate a ranked list of workspace suggestions to the workplace user 1702a. The workplace user receiving the ranked list may the same workplace user who made the request, or may be a different workplace user. The suggestion engine may also communicate suggested amendments to existing bookings to a workplace user 1702a. This may the same workplace user who submitted the request (e.g. which may be in combination with the ranked list of suggested workspace suggestions for the requested new allocation). The suggested amendments may also be ranked based on user preferences.

The suggestion engine 1710 is also configured to receive from a meeting organiser 1702b a request for a suitable meeting room for a list of attendees for a given date range. The suggestion engine is configured to provide a ranked list of suggestions to the meeting organiser 1702b (for example, the list may of a range of meeting date ranges that is ranked based on one or more factors such as the number of attendees that may make it, or the number of people marked as essential/important who can make the meeting, the overall resource utilization or collaborative utilization of the suggestion). The suggestion engine may also provide a suggested list of modified meeting location suggestions. For example, there may already be a meeting scheduled within the specified time range, but the suggestion engine determines that a more optimal time/location combination can be found and suggests the modification to the meeting organizer.

The suggestion engine 1710 is configured to receive communications from a facilities manager 1702c. For example, the facilities manager 1702c issues commands to the suggestion engine to control the opening and closing of zones. The facilities manager 1702c may receive from the suggestion engine suggestions for the opening and closing of zones. These suggestions may be generated as part of the suggested resource allocation determination process. For example, the suggestion engine may determine that it is likely that the currently open resource zones will not be able to accommodate all anticipates resource allocations, either with optimum levels or at all, or the suggestion engine determines that the currently open resource zones are not needed for the currently expected resource allocations, and some zones may be closed to optimise the overall building resource utilization. The suggestion engine 1710 may also communicate capacity management opportunities to the facilities manager.

Capacity management opportunities may include identifying long-term over-utilization or under-utilization of resources or resource zones. For example, if a resource in a resource zone goes unused for a long period of time, then the resource may be retired to reduce power consumption, or to free space that might be used elsewhere. Similarly, if a resource zone or a composite resource zone (such as a floor), then the resource zone or composite resource zone may be permanently retired from use (e.g. shut down an entire floor permanently). Similarly, additional resource zones may be acquired or set up in response to prolonged over-utilization of existing resource zones. For example, a meeting room may be permanently turned into a resource zone with a bank of workstations. Retiring a resource or resource zone permanently prevents allocation of that resource or resource zone. This differs from closing a resource zone, in that a resource zone may be closed for a period of time, but may be reopened. Retired resources or resource zones may be sold off or loaned out, thereby reducing operating costs.

In making the suggested resource allocations, the suggestion engine 1714 utilises a suggestion engine repository 1712 and performs various suggestion processes 1714. For example, the suggestion processes include a workplace suggestion refresh process. In this process, the suggestion engine regularly determines a suggested resource allocation (as described above, this may be on a periodic basis or in response to a trigger such as a request). The suggested resource allocation may thus be regularly refreshed and used for the basis of notifications to persons 1702. As a result of the suggestion process, the workplace suggestions and amendment suggestions are provided to and stored at the suggestion engine repository 1712. These suggestions are stored until they are needed to be provided to persons 1702 as described above.

The suggestion processes 1714 may also include a meeting space suggestion refresh process. In this process, the suggestion engine regularly determines a suggested resource allocation (as described above, this may be on a periodic basis or in response to a trigger such as a request for a meeting). The suggested resource allocation may thus be regularly refreshed and used for the basis of notifications to persons 1702. As a result of the suggestion process, the meeting room and dates suggestions and meeting room relocation suggestions are provided to and stored at the suggestion engine repository 1712. These suggestions are stored until they are needed to be provided to persons 1702 as described above.

The suggestion processes 1714 may also include a zone utilization monitoring process. In this process, the suggestion engine regularly monitors overall zone utilization based on already made allocations and expected future allocations. This process monitors to identify any zones that may be suitable for closure or for opening to better optimise overall resource utilization. As a result of the suggestion process, the zone opening/closure suggestions are provided to and stored at the suggestion engine repository 1712. These suggestions are stored until they are needed to be provided to facilities manager 1702c as described above.

The suggestion processes 1714 may further include a historical actual utilization integration process, in which the suggestion engine 1710 analyses historical information. Each of the workplace suggestions process, meeting space suggestions process and zone utilisation suggestions process may be determined based in part on the historical actual utilization process. As described above, this may include identification of expected utilization patters of permanently allocated resources, historical rates of allocation to determine predicted resource allocation and/or predicted actual utilization for resources that have been allocated to workplace users 1702a.

The historical actual utilization integration process is based on actual utilization metrics, which may be stored in a data repository remote from the suggestion engine 1710 or on the suggestion engine 1710 itself.

The suggestion processes 1714 may include a zone reservation trend monitoring process. In this process trends in resource allocations of each resource zone are monitored over time. The trends can include a rate at which allocations are being made, a rate at which reallocations are being made, and/or a rate at which allocations are being cancelled. The suggestion engine 1710 may observe that a resource zone is trending toward a utilization level that will exceed the maximum utilization threshold or will dip below the lower utilization threshold. As discussed above, the suggestion engine 1710 is able to predict future resource allocations based on the rate of change of resource allocations. The suggestion engine 1710 is thus able to determine a more accurate expected resource utilization that includes the predicted future allocations. The suggested resource allocations may be revised accordingly. For example, the utilization weight for each resource allocation may be continually updated based on determining updated expected resource utilizations based on predicted future resource allocations. The updated utilization weights will have the result of modifying the resource suggestions to steer more resource allocations into a zone that is predicted to be underutilized or to steer resource allocations away from a zone that is predicted to be over-utilized. The suggestion engine 1710 may refer to a series of repositories, including during performance of the suggestion processes 1714. The stores resources may include stored user preferences, a repository storing information on the resources that may be allocated, information identifying zone open and closure rates over time, a workplace meetings reservation repository and a repository identifying users and collaboration groups of those users. These repositories may be separate from, or part of, the suggestion engine 1712.

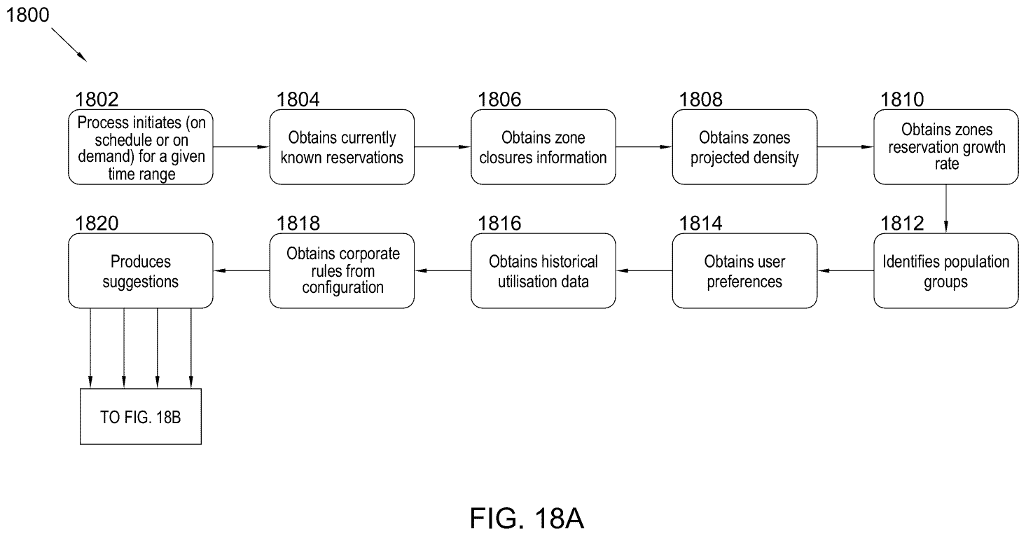

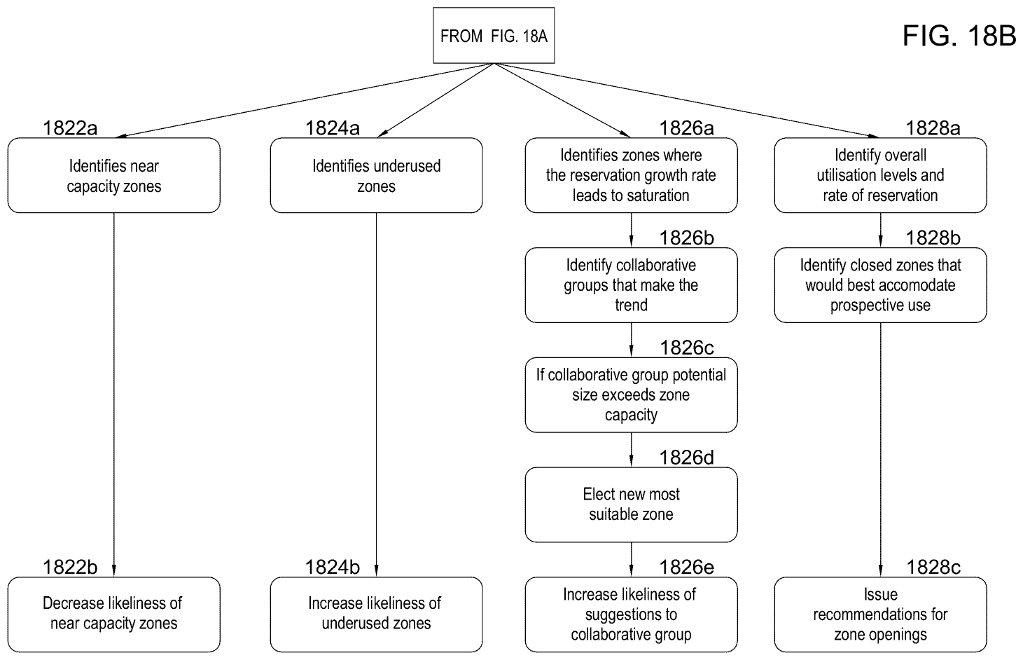

FIG. 18 illustrates an example process for issuing recommendations to building occupants incorporating elements of the above described embodiments for optimising resource allocation. The process initiates at step 1802, which may be a scheduled initiation or on demand (e.g. in response to a trigger), and is conducted for a given time range (e.g. a given week). The process then obtains 1804 currently known reservations (as part of determining a resource utilization across the building). The process then obtains 1806 zone closures information. Zones that are marked as “closed” do not have available resources for allocation, so will not form part of any process to determine a suggested resource allocation. The process then obtains 1808 the projected density (an example of resource utilization) for the open resource zones in the building. As part of the obtaining 1808 projected density, the process obtains zone reservation growth rate. Steps 1808 and 1810 may be carried out as described above in connection with FIG. 4. The process then identifies 1812 population groups—for example, the process identifies collaboration groups within the occupants of the building as described above. The process then obtains 1814 user preferences, obtains 1816 historical utilization data, and obtains 1818 corporate rules, each in the manner described above, for use in determining the suggested allocation as described above. The process then produces suggested resource allocations (in the form of determining suggested resource allocation) in accordance with the embodiments described above, which may include suggested additional allocations as well as suggested reallocations.

FIG. 18 also illustrates different ways in which the determined suggested resource allocation may optimise the resource allocation, in accordance with embodiments described above. The process may include steps 1822a and 1822b, in which the process identifies near capacity zones and decreases the likelihood of additional resources being allocated to the near capacity zones. This includes preferentially suggesting, to an individual requesting allocation of resources, resources in one or more resource zones other than the zones near capacity. The process may include steps 1824a and 1824b, in which the process identifies underused zones and increases the likelihood of additional resources being allocated to the underused zones. This includes preferentially suggesting, to an individual requesting allocation of resources, resources in the one or more of the underused resource zones.

The process may include steps 1826a-1826e, in which the process identifies zones where reservation growth rate leads to saturation, identifies collaborative groups that make the trend, determine if the collaborative group potential size exceeds zone capacity, elects a new most suitable zone and increases likelihood of suggestion to the collaborative group. These steps may be implemented as described above in connection with FIGS. 6A-9D.

The process may include steps 1828a-1828c, in which the process identifies overall utilization levels and rate of reservation, identifies closed zones that would best accommodate prospective use and issue recommendations for zone opening. These steps may be implemented as described above in connection with FIGS. 13 and 14.

The methods and systems described herein may further optimise collaborations between occupants of physical spaces by providing suggestions for allocated resources to maximises opportunities for collaboration between an end user/occupant and other individuals that are most significant to that end user. These most significant collaborators may extend beyond the people the end user may usually interact with (friends and members of the same collaborative group), and may also extend beyond the people the end user has explicit meetings planned with.

In one embodiment, the method of resource utilization optimisation further comprises identifying, for each of at least one occupant of the one or more physical spaces, a list of significant collaborators for the occupant. The method further comprises determining, for each of the at least one occupant and at each time period, a number of resources within the resource zone that have already been allocated to one or more persons on the list of significant collaborators for said occupant. In addition, the determining the suggested resource allocation comprises determining, for each of the at least one occupant, an allocation of one or more resources such that the allocated one or more resources are in spatial proximity to the number of resources already allocated to the one or more significant collaborators. The suggested resource allocation may include a suggested additional resource allocation and/or a suggested reallocation of resources. In this embedment, the suggested allocation is refined to provide further optimisations for collaboration opportunities while also providing recommended allocations/reallocations to optimise utilization of resources and optimisation of collaboration opportunities in accordance with the embodiments described above. Suggesting one or more resources that are in spatial proximity to the number of resources already allocated to the one or more significant collaborators may include determining, for each resource, a collaboration weighting factor. The collaboration weighting factor may be determined based on the degree of spatial proximity of each resource zone to the number of resources already allocated to the one or more significant collaborators.

The lists of significant collaborators may be maintained at a data repository associated with the suggestion engine (for example, the suggestion engine repository). A collaborator for an occupant may be labelled as a significant collaborator if he/she, for example, is an individual that: has a bearing on career advancement for the occupant (such as a line manager); holds valuable information that he/she shares on specially organised events (open enrolment meetings); has seniority or expertise on areas of interest or need to the user is likely to benefit from having potential informal/unplanned access to.

The list of significant collaborators for each end user may be a list of people explicitly selected by the respective end user. The people may include explicitly named individuals, individuals with designated job titles (“Senior Partner”, “Security Evangelist”, “Marketing Spokesperson”) or individuals that form part of designated groups (e.g. department, team or one or more collaborative groups as identified above). This list may, for example, be provided as part of the user preferences identified above. Alternatively, each end user may communicate their list of most significant collaborators to the suggestion engine via the one or more interfaces 108.

In addition, or alternatively, the list may comprise individuals identified from an analysis of historical interactions between occupants/end users of the physical space(s) managed by the suggestion engine. For example, a user may be identified as a significant collaborator by analysing interactions between that user and other users of the system (for example, if the user is observed to be interacting with many individuals or with many individuals with higher seniority). The list of significant collaborators may be continually updated by the system, for example at the same time as performing a period determination of expected resource utilization.

In determining an allocation of resources in spatial proximity to the one or more significant collaborators, the suggestion engine may identify a resource that provides spatial proximity to as many of the one or more significant collaborators as possible (e.g. will allocate a resource within the same resource zone and/or composite resource zone that has the most significant collaborators with already allocated resources within the zone(s)). In addition, or alternatively, the suggestion engine may determine a spatial weighting for each resource to each allocated resource (of the one or more significant collaborators) and assign based on a combined weighting that is based on each spatial weighting. In addition, or alternatively, the suggestion engine may rank the significant collaborators. The suggested allocation of resources may then comprise a list of suggested allocations ranked according to the proximity of the suggested allocations to the ranked significant collaborators. A weighting may be applied based on ranking (and also, potentially based on proximity) so that the suggested allocation takes into account ranking.

The suggestion engine may rank significant collaborators based on the types of interactions observed in the past between the given user and others. For example, the following may be taken into account when determining the ranked list: attendance to meetings organised by the collaborator (or other collaborators matching the profile of the collaborator) that the user attended in person; self-enrolment by the user to open “events” organised by the collaborator; presence of declared significant/meaningful collaborators on a given day; and meetings where both the user and collaborator(s) are invited.

In embodiments utilising the list(s) of significant collaborators, the process of determining a suggested allocation is refined to provide further optimisations for collaboration opportunities. The ongoing suggestion processes described above can integrate the additional refinement based on the list of significant collaborators, which may be continually maintained by the system. Alongside the processes to determine suggestions of allocated resource to optimise resource utilization (as described above), these embodiment allows the system to highlight to the user allocations (resources and time periods) that are preferable based on the presence of significant collaborators. This may be incorporated as part of other rankings as described above.

The suggestion engine may utilize additional information in determining the suggested resource allocation based on the list of significant collaborators. For example, the suggestion engine may determine that a particular user is hosting an event on a given day (e.g. a meeting) with open enrolment event on a given day. The location of that event may be set to be an attractor seed. End users/occupants that have the particular user on their list of most significant collaborators may be provided with a suggested resource allocation proximal to the location and at or proximal to the time period at which the event is taking place. The suggested resource allocation may be, for example, a workstation near to the meeting room where the event is taking place.

Although the suggestion engine will determine the suggested resource allocation that is considered most optimal, users may still be presented with the context pertaining to the time periods the suggestion engine does not identify as optimal. This allows for the user to simply and efficiently make an informed choice should they want to explicitly select one of the alternate options.

The method may also provide opportunities to enhance collaboration opportunities for event organisers based on the lists of significant collaborators. In one embodiment, the method further comprises receiving a request from a user to schedule an event for a time period within the specified time range; identifying a plurality of lists of significant collaborators, each list of significant collaborators associated with a respective occupant of the one or more physical spaces; identifying which of the plurality of lists of significant collaborators includes the user; and identifying the occupants associated with said lists as potential attendees of the event; determining an expected attendee resource utilization for each resource zone for each of a plurality of time periods across a specified time range, the determining an expected resource utilization comprising determining a number of resources within the resource zone that have already been allocated to the potential attendees; determining a suggested time period for the event based on the expected attendee resource allocation.

The expected attendee resource allocation may also comprise a predicted future number of resource allocations to the potential attendees. The predicted future number of resource allocations may be determined based on the rate of allocations in accordance with the embodiments described earlier.

The determination of the suggested time period may further comprise determining the number of resources available to be allocated in one or more resources zones at each time period and identifying a time period with one or more resource zones enough resources for allocation to potential attendees that have not yet been allocated resources at the time period. The suggestion engine may provide a ranked list of suggested time periods, with each suggestion ranked based on, for example, the determined number of available resources, the total number of expected resource allocations for the potential attendees, the likely actual utilization of the allocated resources by the respective attendees at the time period and the suitability of the resources. The suitability of the resources may be based on, for example, user requirements for each of the potential attendees and/or event requirements. The event requirements may include identification of desired resources for the event (for example, if the event to be scheduled is a lecture, then it may be desired to have microphones available for questions and answers).

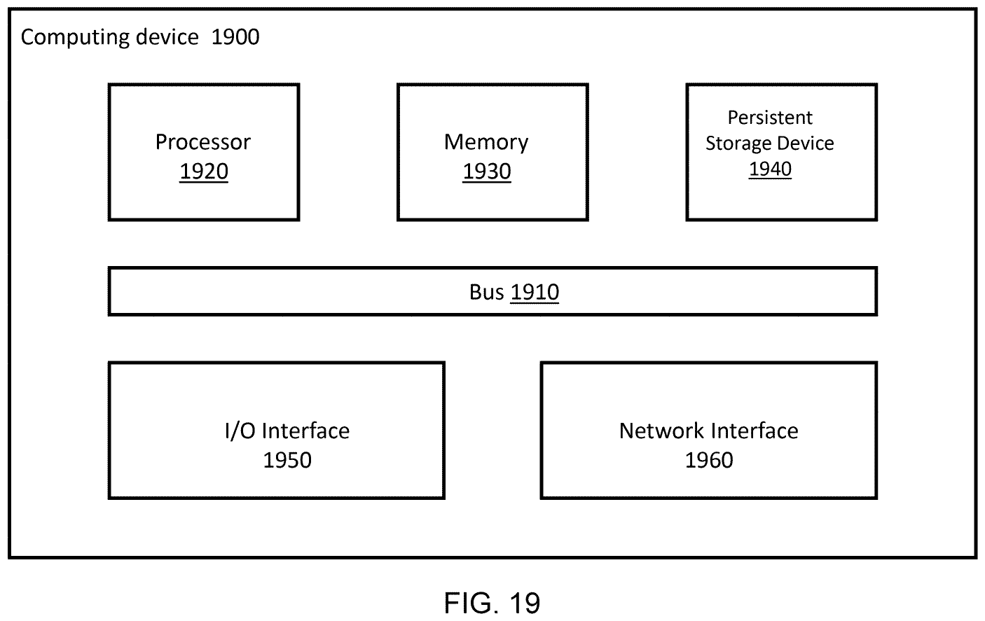

FIG. 19 shows a computing device 1900 using which the embodiments described herein may be implemented. For example, the suggestion engine may be implemented on the computing device 1900.

The computing device 1900 includes a bus 1910, a processor 1920, a memory 1930, a persistent storage device 1940, an Input/Output (I/O) interface 1950, and a network interface 1960.

The bus 1910 interconnects the components of the computing device 1900. The bus may be any circuitry suitable for interconnecting the components of the computing device 1900. For example, where the computing device 500 is a desktop or laptop computer, the bus 1910 may be an internal bus located on a computer motherboard of the computing device. As another example, where the computing device 1900 is a smartphone or tablet, the bus 1910 may be a global bus of a system on a chip (SoC).

The processor 1920 is a processing device configured to perform computer-executable instructions loaded from the memory 1930. Prior to and/or during the performance of computer-executable instructions, the processor may load computer-executable instructions over the bus from the memory 1930 into one or more caches and/or one or more registers of the processor. The processor 1920 may be a central processing unit with a suitable computer architecture. e.g. an x86-64 or ARM architecture. The processor 1920 may include or alternatively be specialized hardware adapted for application-specific operations.

The memory 1930 is configured to store instructions and data for utilization by the processor 1920. The memory 1930 may be a non-transitory volatile memory device, such as a random access memory (RAM) device. In response to one or more operations by the processor, instructions and/or data may be loaded into the memory 530 from the persistent storage device 1940 over the bus, in preparation for one or more operations by the processor utilising these instructions and/or data.

The persistent storage device 1940 is a non-transitory non-volatile storage device, such as a flash memory, a solid state disk (SSD), or a hard disk drive (HDD). A non-volatile storage device maintains data stored on the storage device after power has been lost. The persistent storage device 1940 may have a significantly greater access latency and lower bandwidth than the memory 1930, e.g. it may take significantly longer to read and write data to/from the persistent storage device 1940 than to/from the memory 530. However, the persistent storage 1940 may have a significantly greater storage capacity than the memory 1930.

The I/O interface 1950 facilitates connections between the computing device and external peripherals. The I/O interface 1950 may receive signals from a given external peripheral, e.g. a keyboard or mouse, convert them into a format intelligible by the processor 1920 and relay them onto the bus for processing by the processor 1920. The I/O interface 1950 may also receive signals from the processor 1920 and/or data from the memory 1930, convert them into a format intelligible by a given external peripheral, e.g. a printer or display, and relay them to the given external peripheral.

The network interface 1960 facilitates connections between the computing device and one or more other computing devices over a network. For example, the network interface 1960 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method of optimising allocation of resources in one or more buildings, comprising:
identifying a plurality of resource zones within the one or more buildings, each resource zone comprising a plurality of resources for allocation;
storing a suggested resource allocation for each respective time period of a plurality of time periods across a specified time range;
periodically updating the stored suggested resource allocation for each respective time period of the plurality of time periods by:
for each respective time period of the plurality of time periods across a specified time range:
determining an expected resource utilization for each resource zone by determining a number of resources within the resource zone that have already been allocated to a respective number of persons at the respective time period, wherein the expected resource utilization comprises an indication of the number of resources in a resource zone that have already been allocated for the resource zone for the respective time period;
determining, utilizing a self-learning algorithm, a suggested resource allocation comprising (i) a suggested additional allocation of resources or (ii) a suggested reallocation of already allocated resources, wherein the suggested resource allocation is an allocation of one or more resources in one or more resource zones for the respective time period;
determining, utilizing the self-learning algorithm, an updated expected resource utilization based on an implementation of the suggested resource allocation by comparing the updated expected resource utilization to a specified value range;
updating the stored suggested resource allocation for each respective time period of the plurality of time periods in response to determining that the updated expected resource utilization is within the specified value range;
obtaining data indicative of actual resource zone occupancy density for the plurality of time periods; and
updating parameters of the self-learning algorithm based on a training dataset comprising data generated by comparing the actual resource utilization for the plurality of time periods to the updated expected resource utilization for the plurality of time periods.

2. The computer-implemented method of claim 1, wherein determining the expected resource utilization for each resource zone comprises predicting future allocations of resources for the resource zone, the predicting comprising:
identifying a rate of allocation of resources of the resource zone at each time period; and
determining an expected total number of future allocations at each time period based on the identified rate of allocation, wherein the expected resource utilization further comprises an indication of the expected total number of future allocations.

3. The computer-implemented method of claim 2, further comprising:
identifying a time period within the specified time range at which the expected resource utilization for one or more resource zones falls outside the specified value range;
identifying one or more collaborative groups of persons, each group comprising a plurality of group members;
determining, for each collaborative group, an expected group resource utilization for the time period, the determining the expected group resource utilization comprises:
determining a number of resources of the resource zone already allocated to a respective number of group members;
determining a rate of allocation of resources of the resource zone to group members for each time period and determining an expected total number of future allocations to group members at each time period based on the identified rate of allocation,
wherein the expected group resource utilization comprises an indication of the number of resources within the resource zone that have already been allocated to a respective number of group members at each time period, and an indication of the expected total number of future allocations to group members at each time period; and
determining a suggested group resource allocation, wherein the suggested group resource allocation comprises a suggested additional allocation of resources to group members of a specified group or a suggested reallocation of resources already allocated to group members of the specified group, wherein the suggested group resource allocation is an allocation of one or more resources in one or more resource zones for a suggested time period within the specified time range, such that after allocation according to the suggested group resource allocation, the expected resource utilization of the one or more resource zones for the suggested time period is within a specified value range.

4. The computer-implemented method of claim 3, wherein the specified group is the group having the greatest rate of allocation of resources for a resource zone or the lowest number of resources already allocated to the resource zone.

5. The computer-implemented method of claim 3, further comprising identifying one or more closed resource zones, each closed resource zone comprising a plurality of resources that are not available for allocation, and wherein determining a suggested group allocation further comprises:
opening the one or more closed resource zones to create one or more opened resource zones such that the plurality of resources within the one or more opened resource zones are available for allocation; and
identifying the one or more opened resources zones as the one or more resource zones of the suggested group resource allocation.

6. The computer-implemented method of claim 1, wherein the suggested resource allocation comprises the suggested additional allocation of resources, the method further comprising:
receiving a request for allocation of one or more resources to one or more persons for a time period within a specified time range; and
allocating one or more resources to the one or more persons according to the suggested additional resource allocation.

7. The computer-implemented method of claim 6, wherein the request comprises an indication of user preferences, the user preferences comprising a preferred time period and resource requirements, and wherein the one or more resources of the suggested additional resource allocation are selected based on the user preferences.

8. The computer-implemented method of claim 7, wherein the one or more resources of the resource allocation comprises a list of available resources for allocation ranked according to the user preferences.

9. The computer-implemented method of claim 1, further comprising:
receiving a request to schedule a meeting for a group of attendees for a time period within the specified time range;
identifying attendees of the group yet to be allocated resources within the specified time range; and
determining a suggested group resource allocation, wherein the suggested group resource allocation comprises a suggested additional allocation of resources to group members of the group or a suggested reallocation of resources already allocated to group members of the group, the determining a suggested group resource allocation comprising identifying one or more preferred resource zones as having sufficient resources for allocation to the entire group, and wherein the suggested group resource allocation is an allocation of one or more resources in the one or more preferred resource zones for a suggested time period within the specified time range, such that after allocation according to the suggested group resource allocation, the expected resource utilization of the one or more resource zones for the suggested time period is within a specified value range.

10. The computer-implemented method of claim 9, further comprising
identifying attendees of the group of attendees that already have resources allocated to them within the specified time range; and
determining a revised group resource allocation, the revised group resource allocation being an allocation of one or more alternative resources in one or more resource zones for the attendees that have already been allocated resources for a time period that is not the suggested time period.

11. The computer-implemented method of claim 1, wherein the specified value range comprises one or both of a minimum utilization threshold and a maximum utilization threshold.

12. The computer-implemented method of claim 1, wherein determining the expected resource utilization comprises analysing historical utilization data of each resource zone to determine the expected utilization of permanently allocated resources in the resource zone at each point in time.

13. The computer-implemented method of claim 1, wherein the suggested resource allocation comprises the suggested reallocation of already allocated resources, and wherein the determining a suggested resource allocation comprises:
identifying one or more suboptimal resource zones, each suboptimal resource zone being a resource zone having an expected resource utilization that falls outside the specified value range for a time period within the specified time range; and
identifying an existing resource allocation, the existing resource allocation comprising one or more allocated resources within the one or more suboptimal resource zones at the time period, wherein the suggested reallocation of already allocated resources is an allocation of one or more resources in one or more resource zones at a suggested time period such that after reallocation from the existing allocation to the suggested reallocation, the expected resource utilization of the one or more resource zones for the suggested time period is within the specified value range.

14. The computer-implemented method of claim 13, further comprising:
reallocating resources for the one or more persons from the existing resource allocation to the suggested reallocation.

15. The computer-implemented method of claim 14, wherein the method further comprises, in response to determining that the expected resource utilization at the identified time period is below a minimum utilization threshold of the specified value range:
identifying each of the one or more resource zones having the resource utilization below the minimum utilization threshold as an underutilised resource zone; and
closing each underutilized resource zones such that the resources of the underutilized resource zone can no longer be allocated.

16. The computer-implemented method of claim 15, further comprising turning off or lowering power to a part of an environmental system configured to change an environmental condition of each underutilized zone or turning off or lowering power to each resource within each underutilized zone.

17. The computer-implemented method of claim 1, further comprising identifying a collaborative group of persons comprising a plurality of group members, wherein determining the suggested resource allocation comprises one or both of:
selecting the suggested time period for the allocation of the one or more resources for use by one or more of the plurality of group members such that the suggested time period coincides or overlaps with an allocated time period for one or more resources allocated to one or more other members of the plurality of group members; and
allocating the one or more resources in the one or more resource zones for the suggested time period such that the resources allocated to at least a subset of the plurality of group members are located spatially proximate to each other.

18. The computer-implemented method of claim 17, further comprising:
identifying that the group members of the collaborative group have been allocated a communal resource for a specified time period;
wherein the suggested resource allocation is determined such that the resources allocated to the group members are located spatially proximate to the communal resource.

19. The computer-implemented method of claim 1, further comprising:
identifying, for each of at least one occupant of the one or more buildings, a list of significant collaborators for the occupant; and
determining, for each of the at least one occupant and at each time period, a number of resources within the resource zone that have already been allocated to one or more persons on the list of significant collaborators for said occupant;
wherein determining the suggested resource allocation comprises determining, for each of the at least one occupant, an allocation of one or more resources such that the allocated one or more resources are in spatial proximity to the number of resources already allocated to the one or more significant collaborators.

20. The computer-implemented method of claim 1, further comprising:
receiving a request from a user to schedule an event for a time period within the specified time range;
identifying a plurality of lists of significant collaborators, each list of significant collaborators associated with a respective occupant of the one or more buildings;
identifying which of the plurality of lists of significant collaborators includes the user; and identifying the occupants associated with said lists as potential attendees of the event;
determining an expected attendee resource utilization for each resource zone for each of a plurality of time periods across a specified time range, the determining an expected resource utilization comprising determining a number of resources within the resource zone that have already been allocated to the potential attendees;
determining a suggested time period for the event based on the expected attendee resource utilization.

21. A computing system comprising one or more computing devices, wherein the one or more computing devices comprise one or more processors configured to:
identify a plurality of resource zones within one or more buildings, each resource zone comprising a plurality of resources for allocation;
store a suggested resource allocation for each respective time period of a plurality of time periods across a specified time range; and
periodically updating the stored suggested resource allocation for each respective time period of the plurality of time periods by:
for each respective time period of the plurality of time periods across a specified time range:
determine an expected resource utilization for each resource zone by determining a number of resources within the resource zone that have already been allocated to a respective number of persons at the respective time period, wherein the expected resource utilization comprises an indication of the number of resources in a resource zone that have already been allocated for the resource zone for the respective time period;
determine, utilizing a self-learning algorithm, a suggested resource allocation comprising (i) a suggested additional allocation of resources or (ii) a suggested reallocation of already allocated resources, wherein the suggested resource allocation is an allocation of one or more resources in one or more resource zones for the respective time period;
determine, utilizing the self-learning algorithm, an updated expected resource utilization based on an implementation of the suggested resource allocation by comparing the updated expected resource utilization to a specified value range; and
update the stored suggested resource allocation for each respective time period of the plurality of time periods in response to determining that the updated expected resource utilization is within the specified value range;
obtain data indicative of actual resource zone occupancy density for the plurality of time periods; and
update parameters of the self-learning algorithm based on a training dataset comprising data generated by comparing the actual resource utilization for the plurality of time periods to the updated expected resource utilization for the plurality of time periods.

22. A non-transitory computer-readable medium comprising instructions that, when executed by a processor, cause the processor to:
identify a plurality of resource zones within one or more buildings, each resource zone comprising a plurality of resources for allocation;
store a suggested resource allocation for each respective time period of a plurality of time periods across a specified time range; and
periodically updating the stored suggested resource allocation for each respective time period of the plurality of time periods by:
for each respective time period of the plurality of time periods across a specified time range:
determine an expected resource utilization for each resource zone by determining a number of resources within the resource zone that have already been allocated to a respective number of persons at the respective time period, wherein the expected resource utilization comprises an indication of the number of resources in a resource zone that have already been allocated for the resource zone for the respective time period;
determine, utilizing a self-learning algorithm, a suggested resource allocation comprising (i) a suggested additional allocation of resources or (ii) a suggested reallocation of already allocated resources, wherein the suggested resource allocation is an allocation of one or more resources in one or more resource zones for the respective time period;
determine, utilizing the self-learning algorithm, an updated expected resource utilization based on an implementation of the suggested resource allocation by comparing the updated expected resource utilization to a specified value range; and
update the stored suggested resource allocation for each respective time period of the plurality of time periods in response to determining that the updated expected resource utilization is within the specified value range;
obtain data indicative of actual resource zone occupancy density for the plurality of time periods; and
update parameters of the self-learning algorithm based on a training dataset comprising data generated by comparing the actual resource utilization for the plurality of time periods to the updated expected resource utilization for the plurality of time periods.

23. The method of claim 1, wherein after allocation according to the suggested resource allocation, the expected resource utilization of each resource zone for each time period of the plurality of time periods is within the specified value range.

24. The computing system of claim 21, wherein after allocation according to the suggested resource allocation, the expected resource utilization of each resource zone for each time period of the plurality of time periods is within the specified value range.

25. The non-transitory computer-readable medium of claim 22, wherein after allocation according to the suggested resource allocation, the expected resource utilization of each resource zone for each time period of the plurality of time periods is within the specified value range.
